(19) United States
(12) Patent Application Publication
(10) Pub. No.: US 2021/0110480 A1
(43) Pub. Date: Apr. 15, 2021

(54) INTELLIGENT MACHINE SENSING AND MACHINE LEARNING-BASED COMMERCIAL VEHICLE INSURANCE RISK SCORING SYSTEM

(71) Applicant: TrueLite Trace, Inc., San Jose, CA (US)

(72) Inventor: Sung Bok Kwak, San Jose, CA (US)

(21) Appl. No.: 16/600,537

(22) Filed: Oct. 13, 2019

(51) Int. Cl. G06Q 40/08; G06N 20/00; G07C 5/00

(52) U.S. Cl. CPC G06Q 40/08; G07C 5/008; G06N 20/00

(57) ABSTRACT

An intelligent machine sensing and machine learning-based commercial vehicle insurance risk scoring system utilizes in-vehicle sensors, OBD outputs, and electronic driver logs from real-time monitored commercial vehicles as well as accident-causality historical statistics to produce an accurate insurance risk score per monitored vehicle and its driver. The insurance risk score generated by the intelligent machine sensing and machine learning-based commercial vehicle insurance risk scoring system incorporates multiple insurance risk factors with a variable weighting ratio per factor, which is multiplied by a numerical value per factor, wherein each weighting ratio may be autonomously machine-determined based on the significance of each insurance risk factor to a likelihood of an actual accident or another safety event. Furthermore, the insurance risk score per monitored vehicle or commercial driver is objectively comparable to peer vehicles or drivers in a commercial fleet organization, and can undergo min-max feature scaling in deriving each finalized score.

### BACKGROUND OF THE INVENTION

The present invention generally relates to electronic systems for vehicular risk assessment. More specifically, various embodiments of the present invention relate to machine sensing and machine learning-based commercial vehicle insurance risk scoring systems. Furthermore, various embodiments of the present invention also relate to autonomous machine-sensing and machine determination of commercial vehicle accident and damage risks for objective and accurate vehicle insurance risk score calculations.

Conventional methods of determining insurance risk for commercial vehicles involve data analysis of past and historical records and statistics. For example, an insurance risk price model make take a company's and/or driver's accident history, safety and accident statistics for particular vehicle models and makes, past traffic tickets issued to commercial drivers, and/or other historical data that have already occurred in the past. In the conventional vehicle insurance modeling, past records are used as primary indicators of the future risk. Unfortunately, in many instances, past accident and macro-statistical records are often outdated, inaccurate, or irrelevant for deriving a precise real-time and realistic assessment of insurance pricing risks associated with a particular commercial vehicle company operating a specific set of vehicle fleets and commercial drivers.

In particular, undesirable distortions in insurance premium pricing modeling for a commercial vehicle insurance often originates from a few statistical outliers within an insured company's commercial drivers. For instance, two “troublemaking” truck drivers out of sixty truck drivers in a commercial trucking company may grossly distort the overall insurance risk assessment modeling typically utilized by a vehicle insurance company, which in turn results in higher risk assessment and thus higher insurance premiums for the entire commercial trucking company. In another example, three “troublemaking” trucks equipped with unreliable brake parts that are prone to at-fault accidents, in contrast to other fifty-seven trucks in the commercial trucking company with good and reliable safety records, may also distort the overall insurance risk assessment modeling, as the vehicle insurance company's conventional insurance premium modeling simply points to a higher overall risk assessment for the entire organization. In this case, the conventional insurance premium modeling based on purely historical data would fail to identify the three troublemaking trucks preemptively with a high level of confidence and granularity to offer a discounted quote to the trucking company, if those three trucks were to be removed from the insurance plan.

Therefore, it may be desirable to devise a novel electronic system configured to incorporate vehicular sensory parameters and electronic commercial driver log and behavioral information in real-time to extrapolate most relevant vehicle insurance risk factors for precise determinations of insurance premiums.

Furthermore, it may also be desirable to devise an intelligent machine-determined commercial vehicle insurance risk scoring module for the novel electronic system that infuses historical accident risk statistics and real-time vehicular sensor and driver-related parameters to generate a dynamic and accurate insurance risk score for a particular commercial vehicle or a particular commercial vehicle driver.

In addition, it may also be desirable to utilize the dynamic and accurate insurance risk score derived from the novel electronic system for rapid identification of troublemaking commercial drivers or commercial vehicles that cause outsized insurance premiums, accident risks, and/or regulatory violations. Moreover, it may also be desirable to provide novel electronic user interfaces from the novel electronic system to commercial vehicle fleet operators or insurance companies to identify, alert, and manage insurance risk scores and potential troublemaking entities for reduced insurance premiums, accident risks, and regulatory violations.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, an intelligent machine sensing and machine learning-based commercial vehicle insurance risk scoring system is disclosed. This system comprises: a vehicle on-board diagnostics (OBD) device connected to an engine control unit (ECU), an in-vehicle sensor, or a vehicular control chip in a vehicle to record, diagnose, and generate an engine on or off status, vehicle speed data, acceleration and deceleration data, ambient air temperature data, and diagnostic trouble codes (DTCs) as a raw OBD data stream; a vehicle electronic logging device (ELD) connected to the vehicle OBD device, wherein the vehicle ELD is configured to generate a driver-specific ELD log that contains a currently logged-in driver's on-duty, off-duty, and resting activities associated with the vehicle; an accident-causality historical and statistical database executed on a computer server; an intelligent machine sensing and machine learning-based commercial vehicle insurance risk factor determination module connected to the vehicle OBD device, the vehicle ELD, and the accident-causality historical and statistical database to identify a plurality of insurance risk factors, to assign a numerical value for each insurance risk factor per monitored vehicle, and to determine a weighting ratio per insurance risk factor after analyzing the raw OBD data stream, the driver-specific ELD log, and accident-causality statistics from the accident-causality historical and statistical database, wherein each weighing ratio is directly proportional to a closeness of correlation between an insurance risk factor and an actual accident caused by a particular insurance risk factor; a commercial vehicle insurance risk scoring module connected to the intelligent machine sensing and machine learning-based commercial vehicle insurance risk factor determination module, wherein the commercial vehicle insurance risk scoring module derives a commercial vehicle insurance risk score by multiplying the numerical value for each insurance risk factor per monitored vehicle with the weighting ratio per insurance risk factor to generate a plurality of sub-scores from all insurance risk factors, and then by adding all sub-scores and performing a statistical normalization with a min-max feature scaling to produce the commercial vehicle insurance risk score; an ELD and OBD data transceiver connected to the vehicle ELD and the vehicle OBD device, wherein the ELD and OBD data transceiver is configured to transmit the raw OBD data stream and the driver-specific ELD log to components of the intelligent machine sensing and machine learning-based commercial vehicle insurance risk scoring system located outside the vehicle; and a data communication network configured to provide a wireless data information transfer among the ELD and OBD data transceiver, the accident-causality historical and statistical database, the intelligent machine sensing and machine learning-based commercial vehicle insurance risk factor determination module, and the commercial vehicle insurance risk scoring module.

### BRIEF DESCRIPTION OF DRAWINGS

FIG. 1 shows a high-level system block diagram for intelligent machine sensing and machine learning-based commercial vehicle insurance risk scoring system, in accordance with an embodiment of the invention.

FIG. 2 shows a hardware-level system block diagram for intelligent machine sensing and machine learning-based commercial vehicle insurance risk scoring system, in accordance with an embodiment of the invention.

FIG. 3 shows internal electronic logic block structures for the intelligent machine sensing and machine learning-based commercial vehicle insurance risk factor determination module, in accordance with an embodiment of the invention.

FIG. 4 shows internal electronic logic block structures for the intelligent machine sensing and machine learning-based commercial vehicle insurance risk scoring module, in accordance with an embodiment of the invention.

FIG. 5 shows accident statistics data streams for risk zone, time of day, and other accident statistical factors loaded into the intelligent machine sensing and machine learning-based commercial vehicle insurance risk scoring system, in accordance with an embodiment of the invention.

FIG. 6 shows a commercial insurance risk factor proportional weighting determination and adjustment example, in accordance with an embodiment of the invention.

FIG. 7 shows a “time of day” factor example from accident statistics data streams, in accordance with an embodiment of the invention.

FIG. 8 shows a “fatigue driving” factor derived from the hour-of-service (HoS) intelligent machine-sensing and machine-learning determination, in accordance with an embodiment of the invention.

FIG. 9 shows a “fatigue driving” factor and/or a driving behavior factor derived from the hour-of-service (HoS) intelligent machine-sensing and machine-learning determination, in accordance with an embodiment of the invention.

FIG. 10 shows commercial driver-specific hour-of-service (HoS) violations indicating likelihood of driver fatigue or driver behavior problems, in accordance with an embodiment of the invention.

FIG. 11 shows “worst offender” hour-of-service (HoS) violation determinations from the intelligent machine sensing and machine learning-based commercial vehicle insurance risk scoring system for identifying likelihood of driver fatigue and behavior problems, in accordance with an embodiment of the invention.

FIG. 12 shows property factor and vehicle condition factor (e.g. diagnostic trouble code (DTC)) derived during intelligent machine-sensing and machine-learning determination, in accordance with an embodiment of the invention.

FIG. 13 shows property factor and vehicle condition factor derived from diagnostic trouble code (DTC) occurrence timestamps and DTC descriptions for a commercial vehicle monitored by intelligent machine sensing and machine learning, in accordance with an embodiment of the invention.

FIG. 14 shows a driving behavior factor and a “miles of day” factor derived from a commercial vehicle's ECU, ELD, and other in-vehicle sensors monitored remotely via intelligent machine sensing and machine learning, in accordance with an embodiment of the invention.

FIG. 15 shows commercial vehicle insurance risk scores calculated from the intelligent machine sensing and machine learning-based commercial vehicle insurance risk scoring system, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more novel intelligent machine sensing and machine learning-based commercial vehicle insurance risk scoring systems. These descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention does not inherently indicate any particular order nor imply any limitations in the invention.

For the purpose of describing the invention, a term herein referred to as a “commercial vehicle insurance risk score” is a numerical measure of relative risks to insurance pricing of a commercial vehicle. In a preferred embodiment of the invention, a higher score for one commercial vehicle over a lower score for another commercial vehicle indicates a higher relative risk to the higher-score commercial vehicle, compared to the lower-score commercial vehicle. In some instances, higher commercial insurance risk scores for a group of commercial vehicles may justify imposing higher insurance premiums to the group to account for the higher relative risks for insuring such vehicles. In other instances, higher commercial insurance risk scores may provide an insurance company or a commercial vehicle fleet company a systematic opportunity to remove or reduce vehicles and/or their drivers with insurance risk scores above a predefined threshold value to minimize insurance costs, risks, and/or operational inefficiencies.

In addition, for the purpose of describing the invention, a term herein referred to as a “vehicle on-board diagnostics (OBD) device” is defined as an electronic device installed in a vehicle to collect and/or analyze a variety of vehicle-related data. In one example, the vehicle OBD device outputs many data parameters in real-time, such as vehicle diagnostic information (e.g. engine temperature, oil level, OBD codes, and etc.), fuel consumption-related information, vehicle speed information, vehicle acceleration and deceleration information (i.e. measured in g-force or in SI units), ambient air temperature information, engine rotation-per-minute (RPM) information, vehicle location information, and other vehicle-related data. The OBD device is typically connected to an engine control unit (ECU) and a plurality of in-vehicle control or sensor components, such as an accelerometer, a speedometer, a thermostat, a barometer, an emissions control unit, a vehicle electronics control unit, and any other in-vehicle electronics components to check and diagnose the current condition of each connected vehicle component.

Output data parameters from the vehicle OBD device may be utilized to determine a driver's driving activity status, regulatory compliance on the driver's activities as mandated by municipal, state, or federal authorities, and/or vehicle insurance risks measured by the intelligent machine sensing and machine learning-based commercial vehicle insurance risk scoring system. The output data parameters from the vehicle OBD can also determine a vehicle malfunction status or a vehicle repair need, which can further be utilized by the intelligent machine sensing and machine learning-based commercial vehicle insurance risk scoring system for determining insurance risks, appropriate insurance premiums, and/or removal of “troublemaking” vehicles or drivers who are statistical outliers.

In one example, if the vehicle has a nonzero speed for a certain amount of time while its engine is running, an associated commercial driver's driving activity status may be determined by a vehicle electronic logging device as being engaged in an “on-duty” status. In another example, if the vehicle has a zero speed for a certain amount of time while its engine is idling, the associated commercial driver's driving activity status may be determined by the vehicle electronic logging device as still being engaged in an “on-duty” status. On the other hand, if the vehicle's engine itself is turned off for a certain amount of time, the associated commercial driver's driving activity status may be determined by the vehicle electronic logging device as being “off-duty,” inactive, and/or restful from work. Furthermore, an OBD malfunction code or an abnormal data reading as part of the output data parameters from the vehicle OBD device may indicate or identify the source and the state of the vehicle malfunction.

These data parameters may also be correlated to timestamps generated by an electronic clock associated with the vehicle OBD device. In one embodiment of the invention, the data parameters may be generated by the vehicle OBD device in a region-specific, maker-specific, and/or model-specific format, which requires interpretation and conversion to a compatible output format decodable by a vehicle electronic logging device, a mobile application executed on a portable electronic device, a remotely-located commercial vehicle fleet monitoring station, and/or an intelligent machine sensing and machine learning-based commercial vehicle insurance risk scoring system.

Furthermore, for the purpose of describing the invention, a term herein referred to as a “vehicle electronic logging device,” or an “ELD,” is defined as a specialized driver activity log-generating electronic device connected to a vehicle OBD device. This specialized driver activity log-generating electronic device analyzes real-time OBD output data parameters to objectively derive or confirm an ongoing driver activity and/or vehicle repair needs in a commercial vehicle. For example, a vehicle ELD can measure and objectively confirm a commercial vehicle driver's on-duty driving by tracking a nonzero vehicle speed data parameter and an engine “on” status signal from the vehicle OBD device, until the commercial vehicle driver stops and turns off the engine.

Similarly, the vehicle ELD can objectively measure and confirm the commercial vehicle driver's off-duty resting period with a system clock and a duration of the engine “off” status signal. These machine and sensor-based autonomous determination of driving behaviors, fatigue driving, and/or accumulated miles driving per day can be further utilized as significant factors in calculating and extrapolating insurance risk scores from the intelligent machine sensing and machine learning-based commercial vehicle insurance risk scoring system.

Moreover, the vehicle ELD may be configured to monitor, track, and record vehicle malfunction codes from the OBD device and incorporate them automatically in a driver vehicle inspection report, which may be initiated, updated, or rectified by a commercial vehicle driver and/or a designated auto mechanic. In addition, regulatory compliance related to a required duration of the commercial vehicle driver's rest can also be tracked and alerted to appropriate authorities (e.g. local, national, and/or federal traffic safety enforcement agencies, fleet managers, etc.) and/or insurance companies by the vehicle ELD and/or other components of the intelligent machine sensing and machine learning-based commercial vehicle insurance risk scoring system.

Furthermore, for the purpose of describing the invention, a term herein referred to as an “hour of service,” or “HoS” is defined as a real-time, hourly, and/or minutely-managed and monitored commercial driving activity parameters and logs for commercial vehicle regulatory compliance required by state, municipal, and/or federal government agencies. For example, the intelligent machine sensing and machine learning-based commercial vehicle insurance risk scoring system may incorporate an electronic logging device (ELD) hour-of-service (HoS) audit and correction guidance feature in a vehicle-installed ELD that can provide preemptive regulatory violation (i.e. “pre-violation”) alerts and log amendment capabilities to enable an early-stage correction (i.e. within minutes or hours of a potential pre-violation log element creation) of potentially erroneous commercial driving activity parameters that may have been a result of a driver's carelessness or machine-generated entry errors. Furthermore, the HoS pre-violation or violation alerts may also be utilized as reliable indicators of driver fatigues or driving behavior problems, which are factored into calculation of corresponding insurance risk scores (e.g. increased insurance risk scores for drivers with new pre-violation alerts, etc.) in the intelligent machine sensing and machine learning-based commercial vehicle insurance risk scoring system.

Moreover, for the purpose of describing the invention, a term herein referred to as a “portable electronic device” is defined as a smart phone, a tablet computer, a notebook computer, a special-purpose proprietary ELD data controller device, or another transportable electronic device that can execute a vehicle ELD HoS audit and correction guidance and management application as well as intelligent machine sensing and machine learning-based commercial vehicle insurance risk factor determination and scoring modules for a vehicle fleet operator and/or a vehicle insurance company.

Furthermore, for the purpose of describing the invention, a term herein referred to as a “vehicle fleet monitoring station,” or a “remote monitoring station unit” is defined as a vehicle fleet monitoring location for one or more commercial vehicles in operation. Examples of remote monitoring station units include, but are not limited to, a commercial vehicle operation control center, a regulatory traffic safety enforcement agency, a vehicle insurance risk analysis center, a vehicle monitoring service center, and a fleet vehicle employer's information technology (IT) control center. Typically, the remote monitoring station unit is configured to execute and operate an intelligent machine sensing and machine learning-based commercial vehicle insurance risk scoring system as well as a commercial fleet-level multiple vehicle ELD HoS audit and correction management application in a computer server, a portable electronic device, another computerized device, or a combination thereof.

In addition, for the purpose of describing the invention, a term herein referred to as “computer server” is defined as a physical computer system, another hardware device, a software module executed in an electronic device, or a combination thereof. Furthermore, in one embodiment of the invention, a computer server is connected to one or more data networks, such as a local area network (LAN), a wide area network (WAN), a cellular network, and the Internet. Moreover, a computer server can be utilized by an intelligent machine sensing and machine learning-based commercial vehicle insurance risk scoring system for gathering and analyzing electronically-generated real-time in-vehicle sensor outputs, accident-causality historical statistics downloaded from government agencies, and real-time commercial vehicle driver electronic logs to determine accurate real-time insurance risk scores for commercial vehicles in operation.

One aspect of an embodiment of the present invention is providing a novel electronic system that incorporates vehicular sensory parameters and electronic commercial driver log and behavioral information in real-time to extrapolate most relevant vehicle insurance risk factors for precise determinations of insurance premiums.

Furthermore, another aspect of an embodiment of the present invention is providing an intelligent machine-determined commercial vehicle insurance risk scoring module for the novel electronic system that infuses historical accident risk statistics and real-time vehicular sensor and driver-related parameters to generate a dynamic and accurate insurance risk score for a particular commercial vehicle or a particular commercial vehicle driver.

In addition, another aspect of an embodiment of the present invention is utilizing the dynamic and accurate insurance risk score derived from the novel electronic system for rapid identification of troublemaking commercial drivers or commercial vehicles that cause outsized insurance premiums, accident risks, and/or regulatory violations.

Yet another aspect of an embodiment of the present invention is providing novel electronic user interfaces from the novel electronic system to commercial vehicle fleet operators or insurance companies to identify, alert, and manage insurance risk scores and potential troublemaking entities for reduced insurance premiums, accident risks, and regulatory violations.

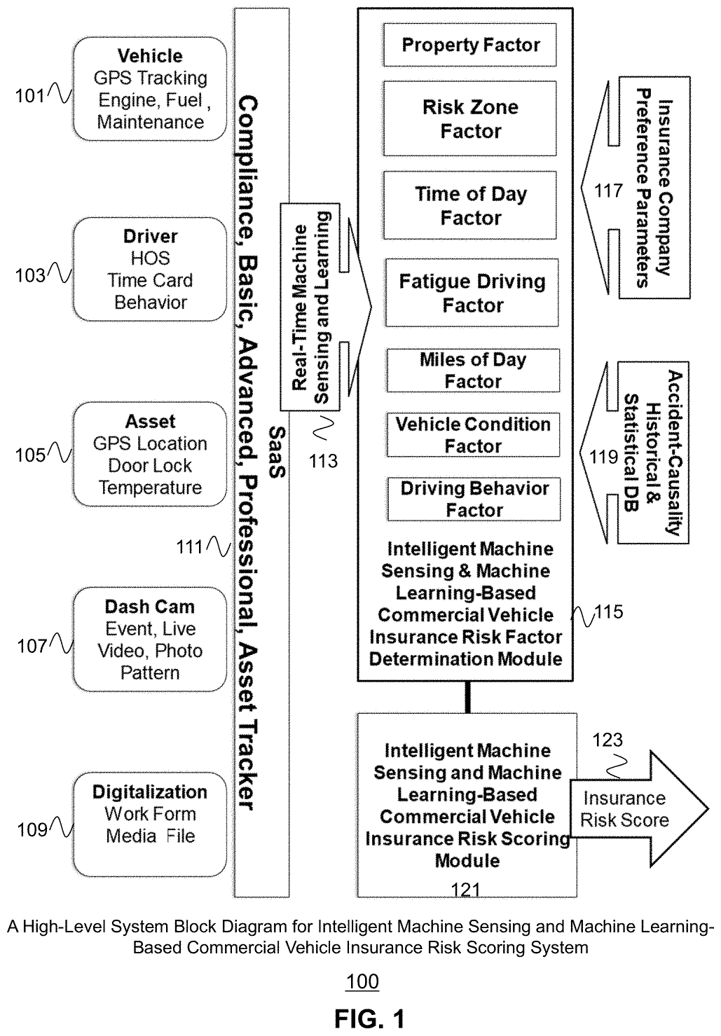

FIG. 1 shows a high-level system block diagram (100) for an intelligent machine sensing and machine learning-based commercial vehicle insurance risk scoring system, in accordance with an embodiment of the invention. In context of the conceptual high-level system block diagram (100), the intelligent machine sensing and machine learning-based commercial vehicle insurance risk scoring system comprises a vehicle and in-vehicle sensors and devices (101) connected to the vehicle, a commercial driver activity-tracking device (103), a commercial trucking load or asset-tracking device (105), a dashboard camera (107), and a commercial driver's log digitalization interface (109), each of which is managed by a “software as a service” (SaaS) commercial vehicle and cargo compliance asset tracking operating software platform (111) that connects each in-vehicle hardware device to other parts of the system via a wireless data modem, a cellular data network, and/or a satellite communication network, as shown in FIG. 1.

In a preferred embodiment of the invention, the SaaS commercial vehicle and cargo compliance asset tracking operating software platform (111) and various in-vehicle hardware devices and sensors (101, 103, 105, 107, 109) enable rapid and real-time in-vehicle sensor and driver behavior-related data parameter transmissions to the remaining parts (e.g. 115, 121) of the system to conduct machine-sensing and machine-learning (113) to determine dynamic in-vehicle components of commercial vehicle insurance risk factors and derive an intelligent machine sensing and machine learning-based commercial vehicle insurance risk score (123), as shown in FIG. 1. Preferably, the intelligent machine sensing and machine learning-based commercial vehicle insurance risk score (123) is calculated and derived after considering both the dynamic in-vehicle components of commercial vehicle insurance risk factors and static macro-data components (e.g. accident-causality historical and statistical database (119)) of the commercial vehicle insurance risk factors to reflect a precise and realistic risk factor in the commercial vehicle insurance risk score (123).

If the commercial vehicle insurance risk score (123) is intended to be utilized by a vehicle insurance company, then the intelligent machine sensing and machine learning-based commercial vehicle insurance risk scoring system may also receive and incorporate the insurance company's preference parameters (117), which may include, for example, data output filter conditions and “worst offending vehicle” or “worst offending driver”-identifying criteria that can realistically reduce risks to a commercial vehicle insurance pricing model for a particular commercial vehicle fleet client. For example, the insurance company may initially request a list of drivers and/or vehicles subject to commercial vehicle insurance risk scores above 90 out of 100 through the insurance company's preference parameters (117) connected to the intelligent machine sensing and machine learning-based commercial vehicle insurance risk scoring system. Then, the insurance company may also require the particular commercial vehicle fleet client to terminate or remove the troublemakers (i.e. “worst offending” drivers and/or related vehicles) scoring above 90 out of 100, if the client wants to continue the insurance coverage at the current insurance premium rates.

Furthermore, in the preferred embodiment of the invention, the in-vehicle sensors and devices (101) integrated into the vehicle include, but are not limited to, an engine control unit (ECU), a vehicle on-board diagnostics device (OBD), a location tracking (e.g. GPS) sensor, a fuel consumption calculator, vehicle maintenance-related sensors, vehicle accelerometers, tire pressure sensors, and any other embedded in-vehicle sensors. Furthermore, the commercial driver activity-tracking device (103) may include an hour-of-service (HoS) commercial driving activity and behavioral analytics device that incorporates government-regulated electronic logging device (ELD) driver log entry and revision capabilities as well as distinctly novel and unique features specific to the HoS analytics device, such as tracking and determining a particular commercial driver's driving behaviors (e.g. speeding, sudden accelerations or decelerations, unsafe cornering), driving fatigue indicators, and granular or subtle real-time driving danger cues (e.g. approaching a dangerous threshold towards a regulatory violation or repeated dangerous driving behaviors within a short timeframe).

For example, the hour-of-service (HoS) commercial driving activity and behavioral analytics system device in the commercial driver activity-tracking device (103) can be configured to provide preemptive regulatory violation (i.e. “pre-violation”) alerts and log amendment capabilities to enable an early-stage correction (i.e. within minutes or hours of a potential pre-violation log element creation) of potentially erroneous commercial driving activity parameters that may have been a result of a driver's carelessness or machine-generated entry errors. Importantly, in context of operating the intelligent machine sensing and machine learning-based commercial vehicle insurance risk scoring system, the HoS pre-violation or violation alerts generated by the hour-of-service (HoS) commercial driving activity and behavioral analytics system device in the commercial driver activity-tracking device (103) may be construed by the intelligent machine as reliable indicators of driver fatigues or driving behavior problems, which are then factored into calculation of corresponding insurance risk scores (e.g. increased insurance risk scores for drivers with new pre-violation alerts, etc.) in the intelligent machine sensing and machine learning-based commercial vehicle insurance risk scoring system.

Furthermore, the commercial trucking load or asset-tracking device (105) may include a GPS-based location tracking capability for shipment items, a door lock sensor in the cargo area of the vehicle to determine loading or unloading timing of the cargo, and/or a cargo area temperature sensor correlated to timestamps to determine historical and real-time ambient temperatures for the cargo area. In the preferred embodiment of the invention, the commercial trucking load or asset-tracking device (105) is operatively connected to machine learning-based commercial vehicle insurance risk factor determination and scoring modules (115, 121) via the SaaS commercial vehicle and cargo compliance asset tracking operating software platform (111) and at least one of the wireless data modem, the cellular data network, and the satellite communication network that accommodate the real-time machine sensing and learning (113), as shown in FIG. 1.

Moreover, the intelligent machine sensing and machine learning-based commercial vehicle insurance risk scoring system may also include the dashboard camera (107) configured to capture live video footages or still photographs around the commercial vehicle, which in turn are further analyzed by the intelligent and autonomous machine via image pattern recognition, facial expression interpretations, road sign identifications, and/or other artificial intelligent-based image recognition techniques to deduce and extrapolate useful real-time clues related to fatigue driving, driving behaviors, vehicle conditions, or other accident risk factors considered in calculation of the intelligent machine sensing and machine learning-based commercial vehicle insurance risk score (123). In addition, the commercial driver's log digitalization interface (109) in the intelligent machine sensing and machine learning-based commercial vehicle insurance risk scoring system is able to convert any paper-based maintenance records, driver logs, hand-written notes, or other non-digital information associated with the commercial vehicle and its drivers into digitized media files that can subsequently be fed into the intelligent machine sensing and machine learning-based commercial vehicle insurance risk factor determination module (115) for identifications of accident risk factors and subsequent machine-determined derivations of the commercial vehicle insurance risk score (123).

Continuing with the embodiment of the invention as shown in FIG. 1, two critical components of the intelligent machine sensing and machine learning-based commercial vehicle insurance risk scoring system are the intelligent machine sensing and machine learning-based commercial vehicle insurance risk factor determination module (115) and the intelligent machine sensing and machine learning-based commercial vehicle insurance risk scoring module (121). In the preferred embodiment of the invention, the intelligent machine sensing and machine learning-based commercial vehicle insurance risk factor determination module (115) gathers dynamic real-time in-vehicle information (e.g. in-vehicle sensor, OBD, and ECU readout values, electronic driver log parameters from a particular commercial vehicle, etc.) through the SaaS commercial vehicle and cargo compliance asset tracking operating software platform (111) and the real-time machine sensing and learning (113) interface, which are configured to communicate with the intelligent machine sensing and machine learning-based commercial vehicle insurance risk factor determination module (115) via a wireless data network.

Furthermore, the intelligent machine sensing and machine learning-based commercial vehicle insurance risk factor determination module (115) also receives macro-statistical information from the accident-causality historical and statistical database (119) and client interface setting information, such as the insurance company preference parameters (117), as shown in the high-level system block diagram (100) in FIG. 1. Various real-time vehicle sensor and electronic log readout values from the vehicle-installed devices (e.g. 101, 103, 105, 107, 109) and the macro-statistical information from the accident-causality historical and statistical database (119) then undergo machine-determined analysis and calculations to constitute a variety of quantifiable weight ratio-based accident risk factor categories.

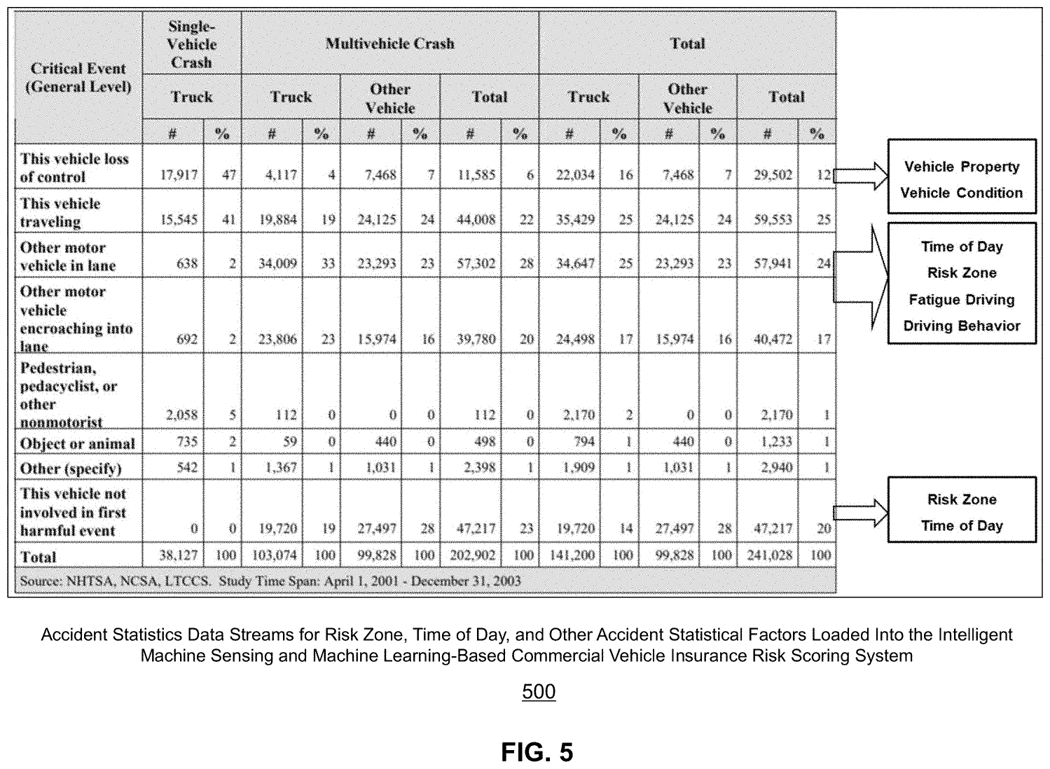

In the preferred embodiment of the invention, the quantifiable weight ratio-based accident risk factors comprise seven distinct categories: a property factor, a “risk zone” factor, a “time of day” factor, a “fatigue driving” factor, a “miles of day” factor, a vehicle condition factor, and a driving behavior factor, as shown in the high-level system block diagram (100) in FIG. 1. As illustrated subsequently in FIGS. 5-11, each of these distinct accident risk factor categories derive their quantifiable values from the real-time vehicle sensor and electronic log readout values transmitted by the vehicle-installed devices (e.g. 101, 103, 105, 107, 109) and the macro-statistical information from the accident-causality historical and statistical database.

Then, as also shown in the high-level system block diagram (100) in FIG. 1, the quantifiable values for each category of accident risk factors are then mathematically weighted, ratioed, and utilized in additional calculations in the intelligent machine sensing and machine learning-based commercial vehicle insurance risk scoring module (121) to derive a novel, commercial vehicle-comparing metric called the “commercial vehicle insurance risk score” (123) for each commercial vehicle subscribed to the SaaS commercial vehicle and cargo compliance asset tracking operating software platform (111). One commercial vehicle insurance risk score derived from the intelligent machine sensing and machine learning-based commercial vehicle insurance risk scoring module (121) for one particular commercial vehicle is designed to be quantitatively and objectively comparable against another commercial vehicle insurance risk score for another commercial vehicle, both commercial vehicles of which are typically operated by the same commercial fleet.

In the preferred embodiment of the invention, a higher numerical value in the commercial vehicle insurance risk score indicates a proportionally higher accident and safety risk for a particular commercial vehicle. Furthermore, the commercial vehicle insurance risk score may be scaled from 0 to 100, wherein the numerical value of “0” indicates the lowest vehicle insurance risk, while the numerical value of “100” indicates the highest vehicle insurance risk due to a higher likelihood of accidents and/or other safety risks. In some cases, each commercial vehicle insurance risk score may be a result of statistical normalizations with min-max feature scaling to bring all comparable values within a certain scale (e.g. 0˜100), even if certain factors and their respective weight ratios are not utilized in a particular data sample. In another embodiment of the invention, the commercial vehicle insurance risk may not be weighted to a rigid scale (e.g. 0˜100), and may not impose any arbitrary upper maximum values in calculating the commercial vehicle insurance scores.

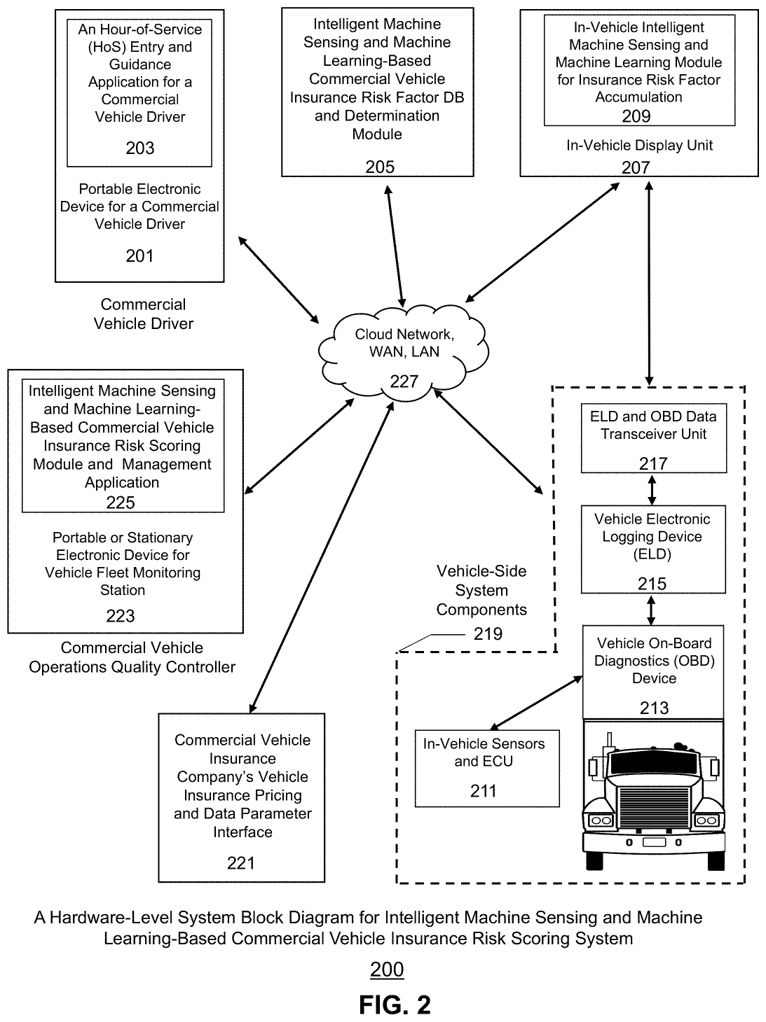

FIG. 2 shows a hardware-level system block diagram (200) for the intelligent machine sensing and machine learning-based commercial vehicle insurance risk scoring system, in accordance with an embodiment of the invention. In a preferred embodiment of the invention, the intelligent machine sensing and machine learning-based commercial vehicle insurance risk scoring system comprises a commercial vehicle (e.g. a truck, a van, a bus, a taxi, or another commercially-classified vehicle), a vehicle on-board diagnostics (OBD) device (213) installed in the commercial vehicle, in-vehicle sensors and an engine control unit (211) connected to the OBD device (213), a vehicle electronic logging device (ELD) (215), an ELD and OBD data transceiver unit (217), a portable electronic device (201) for a commercial vehicle driver, an hour-of-service (HoS) entry and guidance application (203) executed on the portable electronic device (201) for the commercial vehicle driver, a portable or stationary electronic device (223) for a vehicle fleet monitoring station operated by a commercial vehicle operations quality controller, an intelligent machine sensing and machine learning-based commercial vehicle insurance risk scoring module and management application (225) executed on the portable or stationary electronic device (223), an intelligent machine sensing and machine learning-based commercial vehicle insurance risk factor database and determination module (205) executed on a cloud network-connected computer server, and a wired and/or wireless data network (227).

Furthermore, the intelligent machine sensing and machine learning-based commercial vehicle insurance risk scoring system may optionally also include an in-vehicle display unit (207) connected to the vehicle ELD (215) and an in-vehicle intelligent machine sensing and machine learning module for insurance risk factor accumulation (209) executed by the vehicle ELD (215) or by another in-vehicle electronic device per commercial vehicle. Moreover, the intelligent machine sensing and machine learning-based commercial vehicle insurance risk scoring system may also optionally incorporate a commercial vehicle insurance company's vehicle insurance pricing and data parameter interface (221) executed by the cloud network-connected computer server, as shown in the hardware-level system block diagram (200) in FIG. 2. Preferably, the in-vehicle sensors and the ECU (211), the vehicle OBD device (213), the vehicle ELD (215), and the ELD and OBD data transceiver unit (217) are typically incorporated physically in the commercial vehicle as vehicle-side system components (219) of the intelligent machine sensing and machine learning-based commercial vehicle insurance risk scoring system.

The commercial vehicle utilized in the intelligent machine sensing and machine learning-based commercial vehicle insurance risk scoring system is typically a truck, a van, a bus, or another commercial operation-registered vehicle for commercial transport of freight and/or passengers that involve state, federal, municipal, and/or corporate regulations to ensure appropriate levels of commercial drivers' mandatory resting periods between vehicle operations and vehicle maintenance for public safety. The electronic commercial driving activity logs and maintenance recordkeeping requirements are typically based on mileage, calendar days, and/or hours of service for each commercial driver. In another embodiment of the invention, the commercial vehicle may be a private vehicle (i.e. not registered as a commercially-operated vehicle), which is shared among a plurality of drivers via car ride-sharing services or passenger transport services.

Furthermore, the vehicle OBD device (213) is a specialized electronic device installed in the commercial vehicle to collect and/or analyze a variety of vehicle-related data, including engine on/off status, engine temperature, OBD fault codes, speed, acceleration, ambient air temperature, ambient air pressure, engine rotation-per-minute (RPM), vehicle location, and other vehicle-related output parameters generated by an engine control unit (ECU), a transmission control module (TCM), an accelerometer, a barometer, a fuel pressure sensor, and other in-vehicle sensors or other electronic components (e.g. interior room thermometers, door lock status tracking device, vehicle location tracking device, dashcams, etc.) connected to the vehicle OBD device (213). In the preferred embodiment of the invention as shown in FIG. 2, output data parameters from the vehicle OBD device (213) are utilized to formulate at least part of a commercial vehicle electronic driver log that contains a commercial vehicle driver's on-duty/off-duty status, the commercial vehicle driver's resting activity information, vehicle engine on/off time, driving distance information for a particular on-duty timeframe, and other driving activity or status information generated from machines and/or entered by the commercial vehicle driver.

In the preferred embodiment of the invention, these output data parameters from the vehicle OBD device (213) are also stored and categorized by the in-vehicle intelligent machine sensing and machine learning module for insurance risk factor accumulation (209), which is executed by the vehicle ELD (215) or by another in-vehicle electronic device per commercial vehicle. Furthermore, the commercial vehicle electronic driver log or a driver vehicle inspection report (DVIR) may additionally indicate that the commercial vehicle requires repairs or maintenance work based on OBD fault codes or other data parameters generated from the vehicle OBD device (213). The vehicle OBD device (213) may also be utilized to determine a driver's driving activity status and vehicle property or condition factors associated with potential accident or safety risks via the vehicle electronic logging device (ELD) (215), which requires each driver in the commercial vehicle that may be time-shared with other drivers or used exclusively by one driver to log in or log off electronically to indicate time periods of specific driver activity.

Continuing with the embodiment of the invention as shown in FIG. 2, any OBD fault codes or data parameters from the vehicle OBD device (213) that are related to engine on/off statuses and driving activities become part of a particular driver's commercial vehicle electronic driver log automatically even without human intervention, and are further analyzed and stored by the vehicle ELD (215) and the intelligent machine sensing and machine learning-based commercial vehicle insurance risk factor database and determination module (205). Furthermore, a commercial vehicle driver is also typically required to provide at least some manual information entries into the vehicle ELD (215) via the in-vehicle display unit (207), the portable electronic device (201) that executes the HoS entry and guidance application for the commercial vehicle driver (203), or another data entry-capable electronic interface before and after each commercial driving activity to confirm a driver identity and update a current on-duty or off-duty status with the vehicle ELD (215).

In the intelligent machine sensing and machine learning-based commercial vehicle insurance risk scoring system, as illustrated by the hardware-level system block diagram (200) in FIG. 2, commercial vehicle electronic driver logs, OBD codes, and any in-vehicle sensor-originating data parameters that are specific to the commercial vehicle are typically categorized and accumulated by the in-vehicle intelligent machine sensing and machine learning module for insurance risk factor accumulation (209), and the accumulated datasets are also configured to be remotely transmitted to and further processed by the intelligent machine sensing and machine learning-based commercial vehicle insurance risk factor database and determination module (205) via the ELD and OBD data transceiver unit (217) and the wired and/or wireless data network (227).

In the preferred embodiment of the invention, the vehicle-side system components (219) provide the intelligent machine sensing and machine learning-based commercial vehicle insurance risk factor database and determination module (205) a variety of in-vehicle dynamic sensor, driver electronic log, and digitized multimedia parameters for vehicle insurance risk calculations and determinations. Some examples of such dynamic in-vehicle sensory and device readout parameters that can be utilized in formulating commercial vehicle insurance risk factors include, but are not limited to, real-time wireless readouts of vehicle ECU outputs, OBD fault codes, location tracking coordinates, fuel consumption information, vehicle maintenance-related alerts, vehicle accelerometer readout values, tire pressure values, hour-of-service (HoS) commercial driving activity and behavioral information derived from the vehicle ELD (215) and the HoS entry and guidance application for the commercial vehicle driver (203), trucking load or asset-tracking device output values for cargos in the commercial vehicle, and dashboard camera footages that include live video footages or still photographs around the commercial vehicle.

Continuing with the embodiment of the invention as shown in FIG. 2, two critical components of the intelligent machine sensing and machine learning-based commercial vehicle insurance risk scoring system are the intelligent machine sensing and machine learning-based commercial vehicle insurance risk factor database and determination module (205 in FIG. 2, 115 in FIG. 1) and the intelligent machine sensing and machine learning-based commercial vehicle insurance risk scoring module and management application (225 in FIG. 2, 121 in FIG. 1).

In the preferred embodiment of the invention as shown in FIG. 2, the intelligent machine sensing and machine learning-based commercial vehicle insurance risk factor database and determination module (205) gathers dynamic real-time in-vehicle information (e.g. in-vehicle sensor, OBD, and ECU readout values, electronic driver log parameters from a particular commercial vehicle, etc.) through a SaaS commercial vehicle and cargo compliance asset tracking operating software platform and a real-time machine sensing and learning interface, which are configured to communicate with the intelligent machine sensing and machine learning-based commercial vehicle insurance risk factor database and determination module (205) via a wireless data network (e.g. 227).

Furthermore, in the embodiment of the invention as shown in the hardware-level system block diagram (200) in FIG. 2, the intelligent machine sensing and machine learning-based commercial vehicle insurance risk factor database and determination module (205) is also configured to receive macro-statistical information (e.g. large truck crash causation study (LTCCS)) from an accident-causality historical and statistical database, which may be originating from a government agency (e.g. NHTSA, FMCSA) or a private statistics analytics firm. Typically, the macro-statistical information from the accident-causality historical and statistical database explores likely causes of accidents, including the time of the day in each accident, the location of each accident, the vehicle condition prior to each accident, and driver fatigue or behavioral indications.

The macro-statistical information may not have been designed to be derived from particular commercial vehicles and their particular drivers in a particular commercial fleet organization that intends to utilize such macro-statistical data as part of the calculations for the intelligent machine sensing and machine learning-based commercial vehicle insurance risk scoring system. Instead, such macro-statistical data are derived from a large set of general commercial driving populations for macro-level accident statistics analysis, and are merely a part of contributing constituents when the system determines, mathematically weighs, and calculates a commercial vehicle insurance risk score by infusing the dynamic real-time in-vehicle information (e.g. in-vehicle sensor, OBD, and ECU readout values, electronic driver log parameters from a particular commercial vehicle, etc.) with the macro statistical accident-causality data that are not vehicle-specific within the commercial fleet organization.

In addition, the intelligent machine sensing and machine learning-based commercial vehicle insurance risk scoring system also incorporates client interface setting information, such as the insurance company preference parameters, through the commercial vehicle insurance company's vehicle insurance pricing and data parameter interface (221) executed by the cloud network-connected computer server, as shown in the hardware-level system block diagram (200) in FIG. 2. Various real-time vehicle sensor and electronic log readout values from the vehicle-installed devices (e.g. 101, 103, 105, 107, 109 in FIG. 1) and the macro-statistical information from the accident-causality historical and statistical database (e.g. 119 in FIG. 1) then undergo machine-determined analysis and calculations in the intelligent machine sensing and machine learning-based commercial vehicle insurance risk factor database and determination module (205) to generate and populate a variety of quantifiable weight ratio-based accident risk factor categories.

In the preferred embodiment of the invention, the quantifiable weight ratio-based accident risk factors comprise seven distinct categories: a property factor, a “risk zone” factor, a “time of day” factor, a “fatigue driving” factor, a “miles of day” factor, a vehicle condition factor, and a driving behavior factor. As illustrated subsequently in FIGS. 5-11, each of these distinct accident risk factor categories derive their quantifiable values from the real-time vehicle sensor and electronic log readout values transmitted by the vehicle-installed devices (e.g. 101, 103, 105, 107, 109 in FIG. 1) and the macro-statistical information from the accident-causality historical and statistical database.

Then, the quantifiable values for each category of accident risk factors are then mathematically weighted, ratioed, and utilized in additional calculations in the intelligent machine sensing and machine learning-based commercial vehicle insurance risk scoring module and management application (225) to derive a novel, commercial vehicle-comparing metric called the “commercial vehicle insurance risk score” for each commercial vehicle subscribed to the SaaS commercial vehicle and cargo compliance asset tracking operating software platform. One commercial vehicle insurance risk score derived from the intelligent machine sensing and machine learning-based commercial vehicle insurance risk scoring module and management application (225) for one particular commercial vehicle is designed to be quantitatively and objectively comparable against another commercial vehicle insurance risk score for another commercial vehicle, both commercial vehicles of which are typically operated by the same commercial fleet.

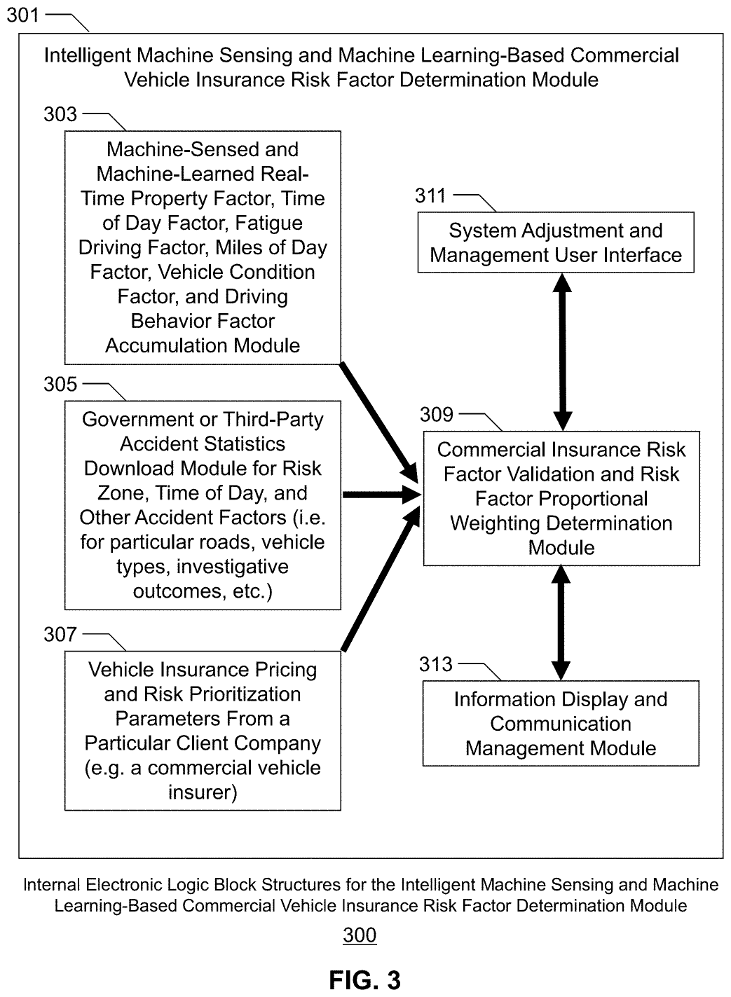

FIG. 3 shows internal electronic logic block structures (300) for the intelligent machine sensing and machine learning-based commercial vehicle insurance risk factor determination module (301), in accordance with an embodiment of the invention. The intelligent machine sensing and machine learning-based commercial vehicle insurance risk factor determination module (301), as shown in this embodiment, comprises a machine-sensed and machine-learned real-time property factor, time of day factor, fatigue driving factor, miles of day factor, vehicle condition factor, and driving behavior factor accumulation module (303), a government or third-party accident statistics download module for risk zone, time of day, and other accident factors (305), a vehicle insurance pricing and risk prioritization parameters (307) from a particular client company, a commercial insurance risk factor validation and risk factor proportional weighting determination module (309), a system adjustment and management user interface (311), and an information display and communication management module (313).

In the intelligent machine sensing and machine learning-based commercial vehicle insurance risk factor determination module (301) as shown in FIG. 3, the machine-sensed and machine-learned real-time property factor, time of day factor, fatigue driving factor, miles of day factor, vehicle condition factor, and driving behavior factor accumulation module (303) receives dynamic in-vehicle machine readout data parameters and electronic driver log information in real time during the operation of the commercial vehicle from the commercial vehicle's ELD and OBD data transceiver unit, which are then categorized, interpreted, and accumulated through machine learning even without a human operator instruction or intervention.

For example, the machine-sensed and machine-learned real-time property factor, time of day factor, fatigue driving factor, miles of day factor, vehicle condition factor, and driving behavior factor accumulation module (303) may autonomously machine-interpret a prolonged driver activity without resting periods, frequently jerky acceleration or braking, and/or unusual lane wandering to categorize these values into the “fatigue driving” factor. In another example, if the driver is also speeding excessively or swerving recklessly, the machine-sensed and machine-learned real-time property factor, time of day factor, fatigue driving factor, miles of day factor, vehicle condition factor, and driving behavior factor accumulation module (303) may autonomously machine-interpret such date into the driving behavior factor. Yet in another example, incoming machine sensor readout parameters from the commercial vehicle that indicate timestamps during the vehicle operation may be categorized into the “time of day” factor, while a reduced tire pressure readout from the driver's side front tire may be categorized into the vehicle condition factor and correlated to the related timestamp.

Furthermore, the government or third-party accident statistics download module (305) in the intelligent machine sensing and machine learning-based commercial vehicle insurance risk factor determination module (301) is configured to receive and categorize static macro-data statistical parameters from an accident-causality historical and statistical database originating from a government agency, an insurance institute, or a third-party analytics firm. In one example, the macro-data statistical parameters from the accident-causality historical and statistical database include macro statistical information related to accidents occurring frequently or less frequently in particular geographic locations, particular time of the day, particular roads, particular vehicle types, and accident investigation outcomes. These macro-data statistical parameters are categorized into “risk zone” factor, “time of day” factor, and other accident factors from the government or third-party accident statistics download module (305).

Moreover, the vehicle insurance pricing and risk prioritization parameters (307) in the intelligent machine sensing and machine learning-based commercial vehicle insurance risk factor determination module (301) enable incorporation of insurance pricing and insurance risk prioritization preferences from a commercial vehicle fleet insurer or another client company that utilizes insurance risk modeling. In one example, the commercial vehicle fleet insurer may want to identify the bottom ten percent of most accident-prone vehicles and/or commercial drivers within the commercial vehicle fleet. Then, based on the finalized insurance risk scores and identified risks from the commercial insurance risk scoring system, the commercial vehicle fleet insurer may offer a discount to insurance pricing, if the fleet operator is willing to remove the bottom ten percent of most accident-prone vehicles and/or commercial drivers from a list of insured vehicles and drivers. In another example, the commercial vehicle fleet insurer may want to identify the bottom twenty percent of commercial drivers who exhibit irresponsible levels of driver fatigues, when sensed by in-vehicle accelerometers, location tracking, electronic driver log resting requirement violations, etc. Then, based on the finalized insurance risk scores and identified risks from the commercial insurance risk scoring system, the commercial vehicle fleet insurer may want to flag the identified bottom twenty percent of such commercial drivers as “uninsurable” drivers by the commercial vehicle fleet insurer, even if those drivers were to move to another commercial fleet.

Continuing with the embodiment of the invention as shown in FIG. 3, the commercial insurance risk factor validation and risk factor proportional weighting determination module (309) in the intelligent machine sensing and machine learning-based commercial vehicle insurance risk factor determination module (301) is configured to determine autonomously (i.e. without a human operator intervention) a relative significance of one insurance risk factor vs. another. The machine determination of the relative significance of insurance significance factors depends heavily on a machine-determined correlation between a particular insurance risk factor and a propensity towards a real accident in the current timeframe. For example, if the fatigue driving factor is showing the highest correlation to real accidents, while the “time of day” factor is exhibiting the second highest correlation to accidents and the “miles of day” factor is reflecting the lowest correlation to accidents, then the commercial insurance risk factor validation and risk factor proportional weighting determination module (309) may assign the highest proportional weighting to the fatigue driving factor, the second highest proportional weighting to the “time of day” factor, and the lowest proportional weighting to the “miles of day” factor.

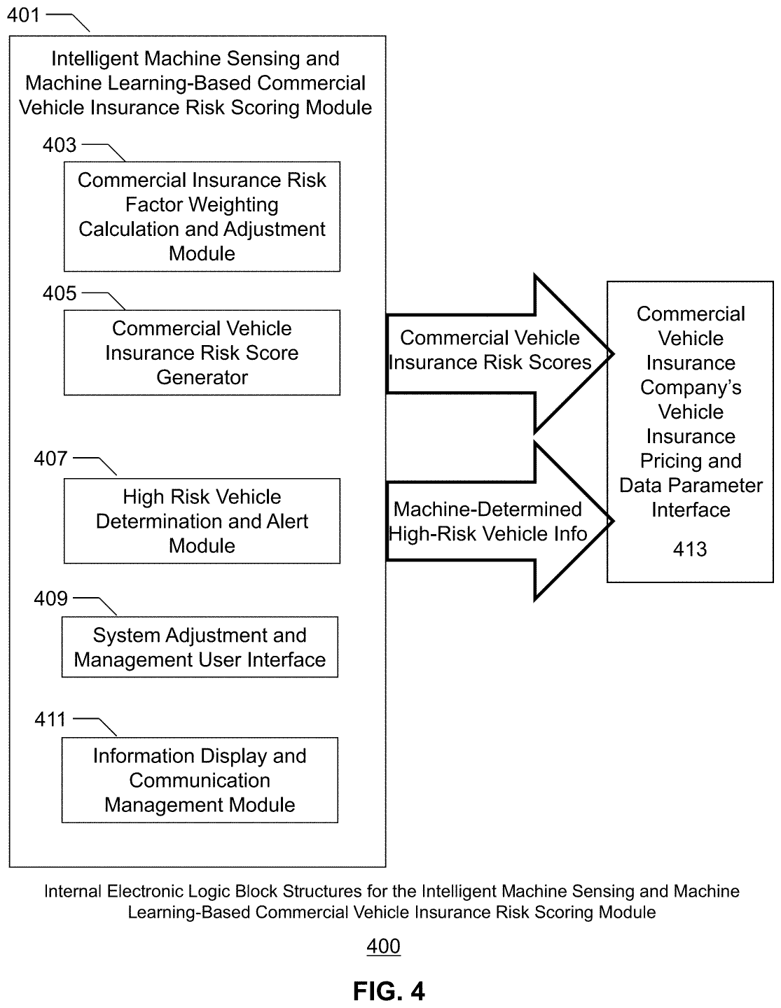

Importantly, in the preferred embodiment of the invention, the machine-determined proportional weighting is autonomously and dynamically determined periodically or in real time while not necessitating a human operator intervention or manual adjustments, based on the inflow of machine-sensed dynamic in-vehicle sensor readout parameters that stream into the intelligent machine sensing and machine learning-based commercial vehicle insurance risk factor determination module (301). The machine-determined proportional weighting of insurance risk factors are subsequently utilized by a vehicle insurance risk scoring module (e.g. 121 in FIG. 1, 225 in FIG. 2, 401 in FIG. 4) to derive an objectively-comparable commercial vehicle insurance risk scores for a plurality of commercial vehicles in a commercial fleet organization.

Furthermore, for some instances where a human operator intervention or adjustment is desired by the commercial fleet organization or the commercial vehicle insurer, the system adjustment and management user interface (311) in the intelligent machine sensing and machine learning-based commercial vehicle insurance risk factor determination module (301) allows a method for the human operator to manually adjust or intervene in specifying particular weighting proportions on various commercial insurance risk factors. In a typical operating circumstances of the system, however, the intelligent machine sensing and machine learning-based commercial vehicle insurance risk factor determination module (301) is configured to be fully autonomous from the human operator in making quantitative and qualitative decisions for insurance risk factor proportional weighting determinations and real-time dynamic changes to such machine-initiated weighting determinations, based on the dynamic changes to the incoming in-vehicle sensor and ELD data readout values.

In addition, the information display and communication management module (313) in the intelligent machine sensing and machine learning-based commercial vehicle insurance risk factor determination module (301) enables the human operator or another client to review the quantitative and/or qualitative output values from the commercial insurance risk factor validation and risk factor proportional weighting determination module (309), as shown in FIG. 3. The information display and communication management module (313) also allows data communication of the quantitative and/or qualitative output values from the commercial insurance risk factor validation and risk factor proportional weighting determination module (309) with other modules (e.g. 121 in FIG. 1, 225 in FIG. 2, 221 in FIG. 2, 401 in FIG. 4) in the intelligent machine sensing and machine learning-based commercial vehicle insurance risk scoring system.

FIG. 4 shows internal electronic logic block structures (400) for the intelligent machine sensing and machine learning-based commercial vehicle insurance risk scoring module (401), in accordance with an embodiment of the invention. Preferably, the intelligent machine sensing and machine learning-based commercial vehicle insurance risk scoring module (401) comprises a commercial insurance risk factor weighting calculation and adjustment module (403), a commercial vehicle insurance risk score generator (405), a high risk vehicle determination and alert module (407), a system adjustment and management user interface (409), and an information display and communication management module (411), as shown in FIG. 4.

The commercial insurance risk factor weighting calculation and adjustment module (403) is configured to fetch and/or calculate a quantified value for a particular commercial insurance risk factor associated with a particular commercial vehicle, and then multiply that quantified value of the particular commercial insurance risk factor with the machine-determined weight ratio for that factor. Typically, the machine-determined weight ratio for the particular commercial insurance risk factor is processed and transmitted from the commercial vehicle insurance risk factor determination module (e.g. 301 in FIG. 3). The outcome of the multiplication of the quantified value of the particular commercial insurance risk factor with the machine-determined weight ratio for that factor is a weight-adjusted numerical value for the particular commercial insurance risk factor. This calculation can be iterated for all of the commercial insurance risk factors from the commercial insurance risk factor weighting calculation and adjustment module (403) per monitored commercial vehicle.

Then, in the preferred embodiment of the invention, each weight-adjusted numerical value for each commercial insurance risk factor category per vehicle can be summed together in the commercial vehicle insurance risk score generator (405) to derive a commercial vehicle insurance risk score per monitored vehicle. In some cases, each commercial vehicle insurance risk score may be a result of statistical normalizations with min-max feature scaling to bring all comparable values within a certain scale (e.g. 0˜100), even if certain factors and their respective weight ratios are not utilized in a particular data sample.

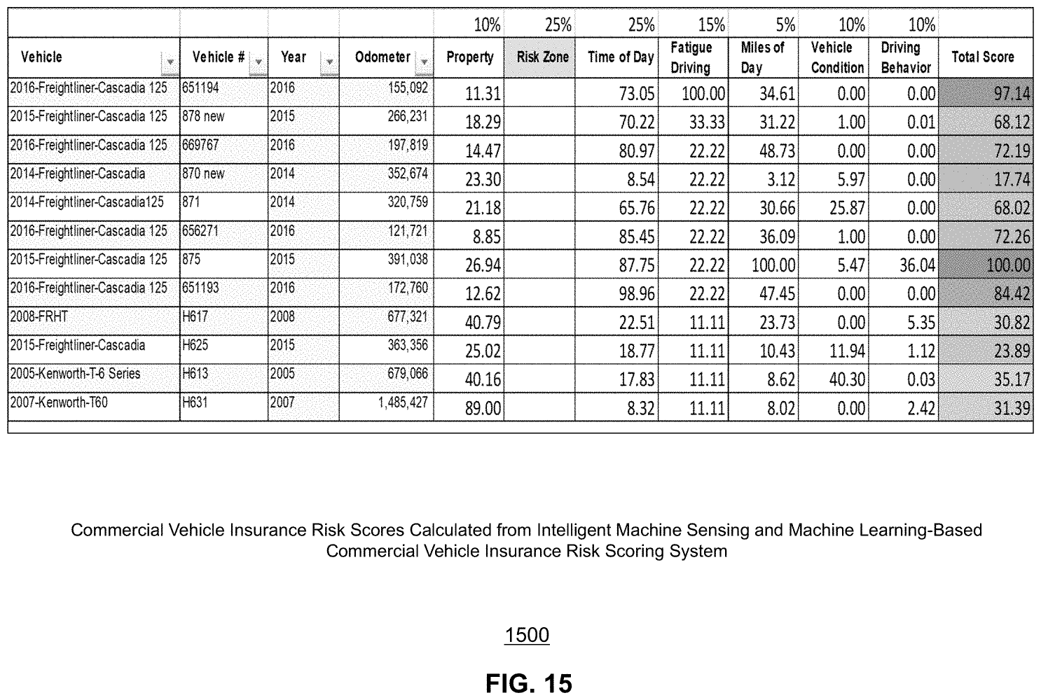

Furthermore, in the preferred embodiment of the invention, a higher numerical value in the commercial vehicle insurance risk score indicates a proportionally higher accident and safety risk for a particular commercial vehicle. For example, the commercial vehicle insurance risk score may be scaled from 0 to 100, wherein the numerical value of “0” indicates the lowest vehicle insurance risk, while the numerical value of “100” indicates the highest vehicle insurance risk due to a higher likelihood of accidents and/or other safety risks. Statistical min-max feature scaling may be utilized to compute the normalized final insurance risk score, which becomes comparable against other scores from other vehicles within the preferred range of scale (e.g. 0˜100). FIG. 15 illustrates this intuitive numerical scale ranging from 0 to 100 for the commercial vehicle insurance risk score in the preferred embodiment.

In another embodiment of the invention, the commercial vehicle insurance risk may not be weighted to a rigid scale (e.g. 0˜100), and may not impose any arbitrary upper maximum values in calculating the commercial vehicle insurance scores. Moreover, a plurality of weight-adjusted numerical values for all risk factor categories may undergo calculations other than above-mentioned summations per weighted factor (e.g. deriving a weighted average of all values or a median value from the plurality of weight-adjusted numerical values instead) in other embodiments of the commercial vehicle insurance risk score generator (405).

Continuing with the embodiment of the invention as shown in FIG. 4, the high risk vehicle determination and alert module (407) in the intelligent machine sensing and machine learning-based commercial vehicle insurance risk scoring module (401) is configured to identify and provide a list of “high risk” vehicles for insurance purposes from a pool of real-time monitored commercial vehicles in a commercial fleet organization. In one embodiment, the high risk vehicle determination and alert module (407) may autonomously set threshold values, without a human operator intervention, for defining the high risk vehicle list criteria based on in-vehicle sensor and electronic log readout values and macro-statistical data for accident causality. In another embodiment, the threshold values for defining the high risk vehicle list criteria may be manually defined and set by a human operator or an insurance company's preference parameters via the system adjustment and management user interface (409) for vehicle insurance risk visualizations through the information display and communication management module (411), as shown in FIG. 4.

A plurality of commercial vehicle insurance scores for a monitored vehicle fleet from the commercial vehicle insurance risk score generator (405) and machine-determined high risk vehicle information from the high risk vehicle determination and alert module (407) are then transmitted to a commercial vehicle insurance company's vehicle insurance pricing and data parameter interface (413), as shown in FIG. 4. In the preferred embodiment of the invention, the commercial vehicle insurance company's vehicle insurance pricing and data parameter interface (413) is executed on a computer server operated by the vehicle insurer or the commercial vehicle fleet organization, and the plurality of commercial vehicle insurance scores and the high risk vehicle information received from the intelligent machine sensing and machine learning-based commercial vehicle insurance risk scoring module (401) are subsequently utilized by the vehicle insurer in deriving insurance premium calculations, compiling a list of high-risk drivers and/or vehicles for exclusion from insurance purposes, and other applications associated with vehicle insurance business.

FIG. 5 shows accident statistics data streams (500) for risk zone, time of day, and other accident statistical factors, which are loaded into the intelligent machine sensing and machine learning-based commercial vehicle insurance risk scoring system, in accordance with an embodiment of the invention. Typically, macro accident-causality statistics collected from numerous real-life accidents are particularly useful in identifying and/or categorizing accident-prone risk zones and accident-prone time in a 24-hour period. As shown in FIG. 5, these macro accident-causality statistics can be subdivided into single vehicle crashes and multi-vehicle crashes by vehicle types (i.e. trucks or other vehicles), which are further categorized by likely causes of accidents as “critical events.”

Examples of such critical events include, but are not limited to, vehicles' loss of control, traveling or stationary status of vehicles, other vehicles in the lane resulting in accidents, other vehicles encroaching into the lane resulting in accidents, pedestrians, animals, or objects involved in accidents, and second-derivative accidents (i.e. “vehicle not involved in first harmful event), which can be further categorized by specific geographic zones and times of day. In some embodiments of the invention, these macro accident-causality statistics can also be utilized by the intelligent machine sensing and machine learning-based commercial vehicle insurance risk scoring system in determining vehicle property, vehicle condition, fatigue driving, and/or driving behavior factors in commercial vehicle insurance risk score derivations.

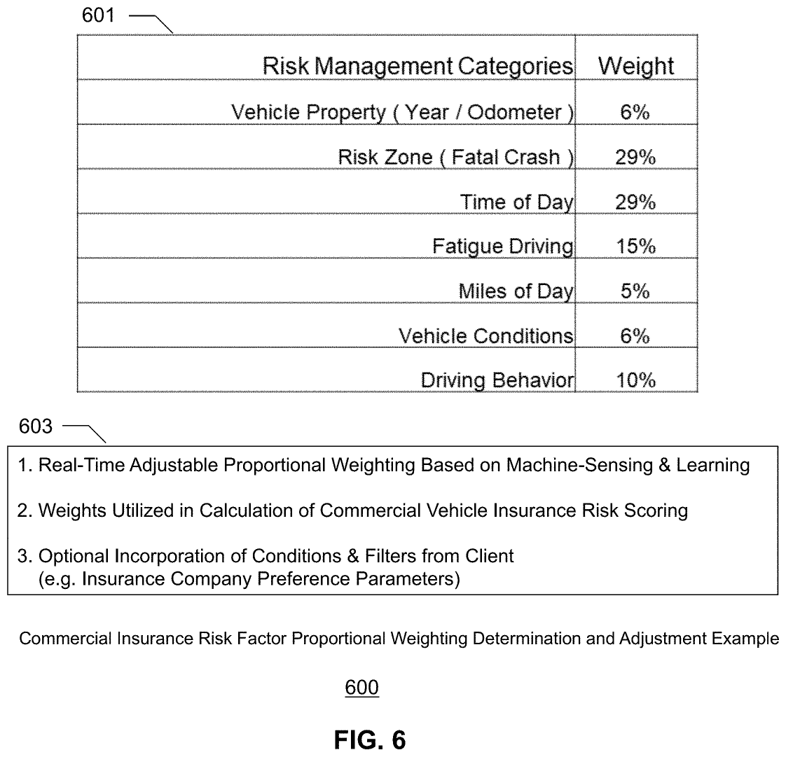

FIG. 6 shows a commercial insurance risk factor proportional weighting determination and adjustment example (600), in accordance with an embodiment of the invention. In this example, the commercial vehicle insurance risk factors are divided into seven categories (601): (1) vehicle property factor (e.g. production year, current odometer reading, etc.), (2) risk zone factor (e.g. frequency of fatal crashes categorized by geographic locations), (3) time of day factor (e.g. frequency of accident occurrences categorized by specific times within the 24-hour period), (4) fatigue driving factor (e.g. indications of driver fatigues correlating to accidents), (5) miles of day factor (e.g. frequency of accident occurrences correlating to the number of miles driven on the day of each accident), (6) vehicle condition factor (e.g. ECU trouble codes, OBD trouble codes, tire pressure sensor warning indicators, vehicle maintenance overdue warning indicators, etc.), and (7) driving behavior factor (e.g. speeding above legal limits, frequent sudden accelerations or decelerations, abnormal and frequent swerving, etc.).

Furthermore, in the commercial insurance risk factor proportional weighting determination and adjustment example (600) as shown in FIG. 6, the proportional weightings for each commercial vehicle insurance risk factor are autonomously machine-determined by the system based on in-vehicle sensor and electronic log readouts and macro accident-causality statistics from a third-party agency. In general, a commercial vehicle insurance risk factor that shows the highest correlation to real-life accidents in recent streams of incoming datasets receives the proportionally-highest weighting value, while another insurance risk factor that shows the second highest correlation to real-life accidents receives the proportionally second-highest weighting value. Likewise, a commercial vehicle insurance risk factor that shows the lowest correlation to real-life accidents receives the proportionally lowest weighting value.

In the commercial insurance risk factor proportional weighting determination and adjustment example (600), the vehicle property factor is assigned a six percent weight, while the risk zone factor and the time of day factor are each assigned a twenty-nine percent weight, respectively, for overall calculation of the insurance risk score. Moreover, the fatigue driving factor is assigned a fifteen percent weight and the miles of day factor is assigned a five percent weight, while the vehicle condition factor is assigned a six percent weight and the driving behavior factor is assigned a ten percent weight for the overall calculation of the insurance risk score. In this example, the weighting scale is designed to be out of one hundred percent when all insurance risk factors are combined to produce a single insurance risk metric called the “commercial vehicle insurance risk score,” for each monitored commercial vehicle.

The commercial insurance risk factor proportional weighting determination and adjustment example (600) also illustrates some of the key features (603) of the commercial vehicle insurance risk scoring system as embodied in this invention. In particular, the proportional weighting for each commercial vehicle insurance risk factor is based on real-time machine-determined adjustments from machine-sensing and machine-learning of incoming real-time in-vehicle sensor and electronic driver log readout parameters as well as monitored vehicle-independent accident-causality statistics from a macro-level vehicle accident analytical entity (e.g. a government agency, an insurance institute, a third-party analytical firm, etc.). Furthermore, the proportional weighting is utilized subsequently in calculating a commercial vehicle insurance risk score per monitored vehicle. In addition, an insurance company's or another client's data condition or filter preference can also be incorporated into the system for client-tailored identification of high-risk vehicles, drivers, and insurance risk scores, as shown in FIG. 6.

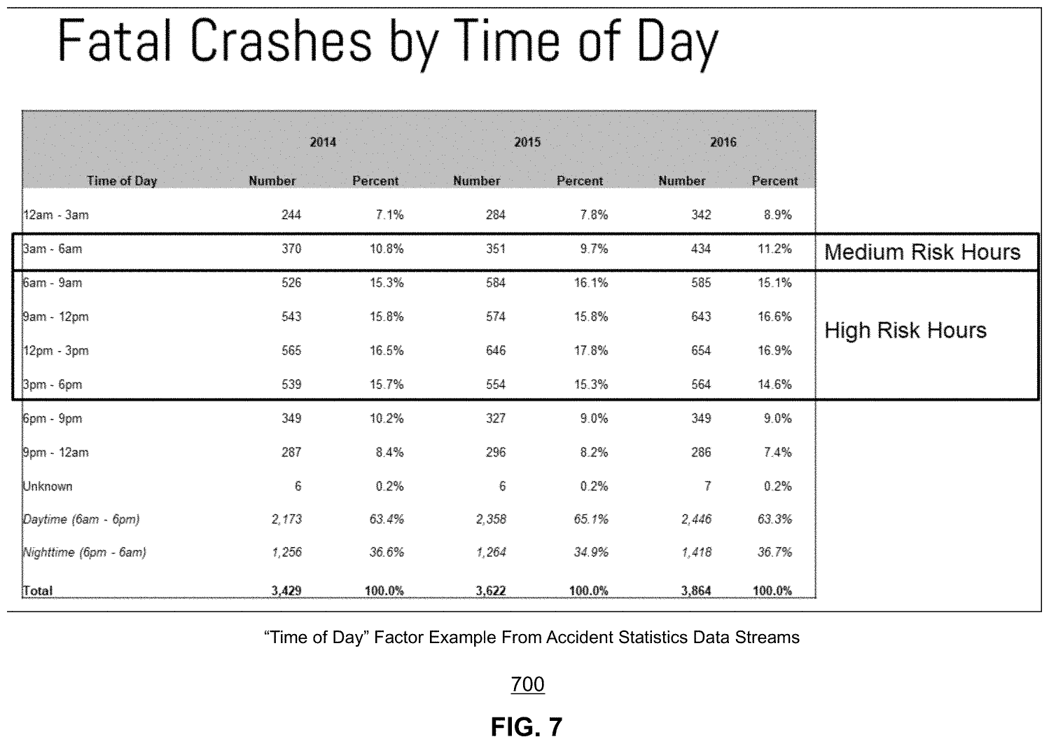

FIG. 7 shows a “time of day” factor example (700) from accident statistics data streams, in accordance with an embodiment of the invention. This “time of day” factor example (700) identifies accident-prone “high risk hours” (i.e. 6 am-6 pm), “medium risk hours” (i.e. 3 am-6 am), and “low risk hours” (i.e. time brackets outside of high risk and medium risk hours), based on annual accident statistics and accident occurrence time during a 24-hour cycle. In the preferred embodiment of the invention, the “time of day” factor for commercial insurance risk determination is typically sourced from macro-level accident statistics originating from an accident-causality historical and statistical database (e.g. 119 in FIG. 1). Furthermore, the time of day factor for commercial insurance risk score calculations typically is assigned a higher numerical value if a particular commercial vehicle is operating more heavily during “high risk hours.” In contrast, a commercial vehicle that operates more heavily during “low risk hours” is assigned a lower numerical value for calculating the “time of day” factor portion of the insurance risk score, thus resulting in a lower insurance risk score component for the “time of day” factor.

In the preferred embodiment of the invention, the weighting ratio for the “time of day” factor in context of the overall calculation of an insurance risk score is not typically derived from a single vehicle-specific monitoring activity, such as real-time readouts from in-vehicle sensors or electronic driver logs. However, in some embodiments of the invention, sensor or driver log readouts from numerous vehicle-specific monitoring activities may also be utilized in determining the weighting ratio for the “time of day” factor by assigning quantitative significance to timing of past accident occurrences in various accidents in a 24-hour cycle.

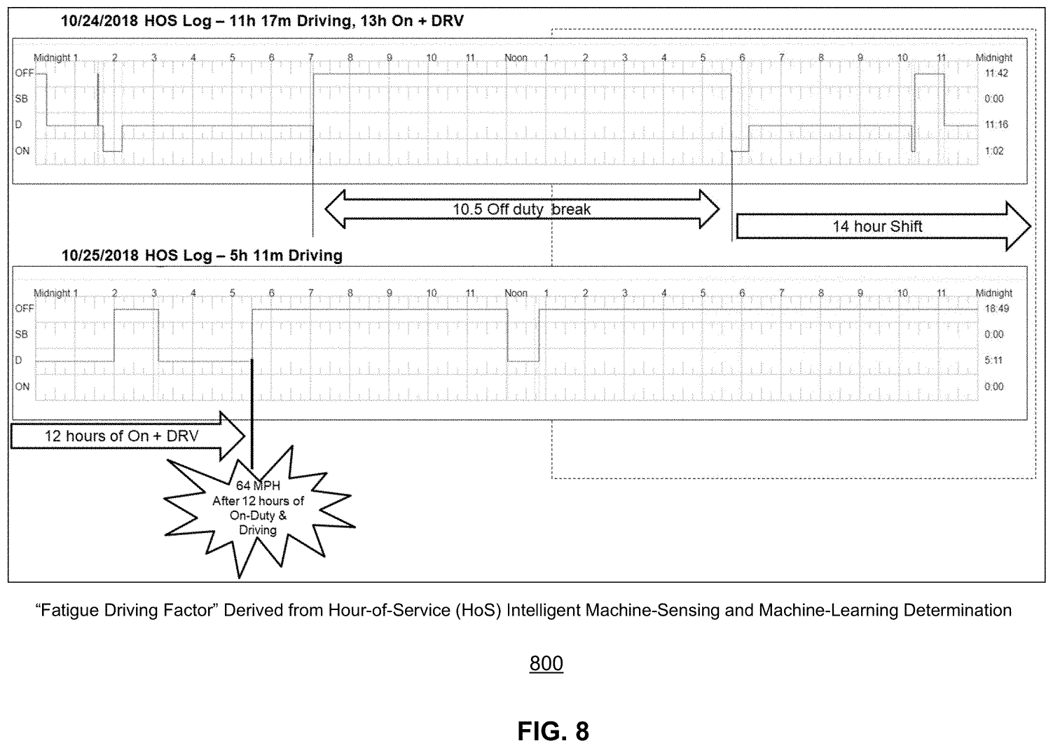

FIG. 8 shows an example (800) of a “fatigue driving” factor derived from the hour-of-service (HoS) intelligent machine-sensing and machine-learning determination, in accordance with an embodiment of the invention. In this example (800), the electronic logging device for the commercial driver records engoine on/off periods and nonzero speed movement of the car, in addition to the commercial driver entry of driving and resting activities. Based on the vehicle sensor (e.g. ECU, speedometer, OBDr readouts, etc.) records and driver electronic logging device records, the HoS intelligent machine-sensing can produce a highly reliable indicator of driver's fatigue. In particular, the system modules (e.g. 115 in FIG. 1, 205 in FIG. 2, 303 in FIG. 3) can detect a dangerous level of continuous driving activity by the commercial driver based on the HoS intelligent machine sensing. In some cases, the continuous driving activity may also result in an outright regulatory violation of mandatory resting periods. In other cases, even if the regulatory violations have not occurred, a chronic overworked driving activity can be highly correlated to a likelihood of an accident.

In the example (800) as shown in FIG. 8, the commercial driver conducts a 14-hour continuous shift, followed by another tiring schedule, with a machine-sensed evidence of the “engine on” (e.g. “on duty” cycle) status and intermittent driving for an additional 12 hours before getting involved in an accident at 64 miles per hour. In this particular example, the system can autonomously determine (i.e. even without a human operator intervening in the system) that the commercial driver was most likely overly fatigued prior to the accident. The commercial vehicle insurance risk factor determination and scoring modules can assign a higher numerical value for the “fatigue driving” factor in calculating the commercial vehicle insurance risk scores for this particular commercial driver who underwent the accident after an irresponsibly-strenuous driving schedule. Furthermore, if such fatigue incidents become more pronounced in a larger dataset in accident-causality correlations for a plurality of commercial vehicles, the overall weighting ratio for the “fatigue driving” factor in insurance risk score calculations will be increased accordingly, relative to other insurance premium risk factors.

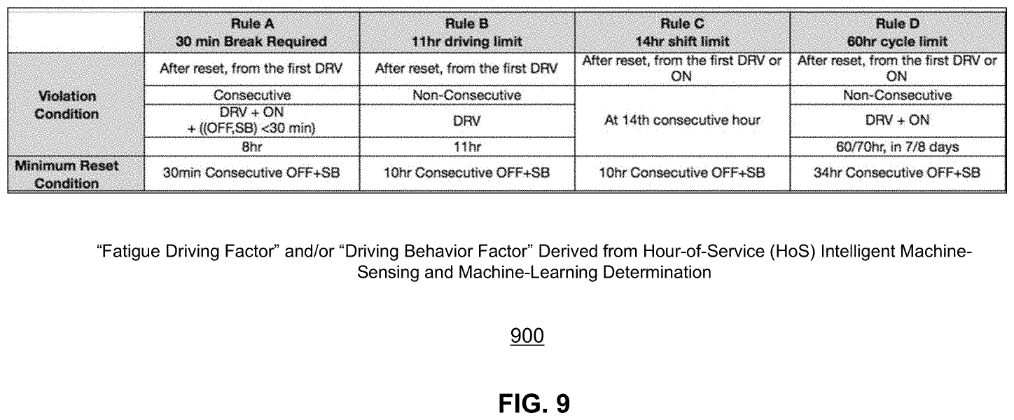

FIG. 9 shows an example (900) of a “fatigue driving” factor and/or a driving behavior factor derived from the hour-of-service (HoS) intelligent machine-sensing and machine-learning determination, in accordance with an embodiment of the invention. The fatigue driving and/or driving behavior factors for insurance risk assessment in this example (900) are originate from various regulatory violation conditions imposed by a government agency (e.g. US Depailinent of Transportation) on commercial drivers for mandatory breaks and limits on driving hours for accident prevention and safety.

For example, the government agency may require a mandatory 30 minute break after a consecutive 8-hour drive, and determine compliance by engine on/off status and/or electronic driver log updates. Likewise, the government agency may require an 11-hour driver operations limit even if the driving was non-consecutive, a 14-hour shift limit, or a 60-hour cycle limit per week, as illustrated in FIG. 9. If the in-vehicle sensors and/or electronic logging devices detect that a monitored commercial driver is getting close to the regulatory violation threshold (i.e. termed herein as a “pre-violation” state), or has already exceeded threshold, the fatigue driving factor and the driving behavior factors become numerically more significant (e.g. greater in magnitude) for that particular commercial driver, thus resulting in a higher insurance risk score relative to drivers with less or no regulatory violations.

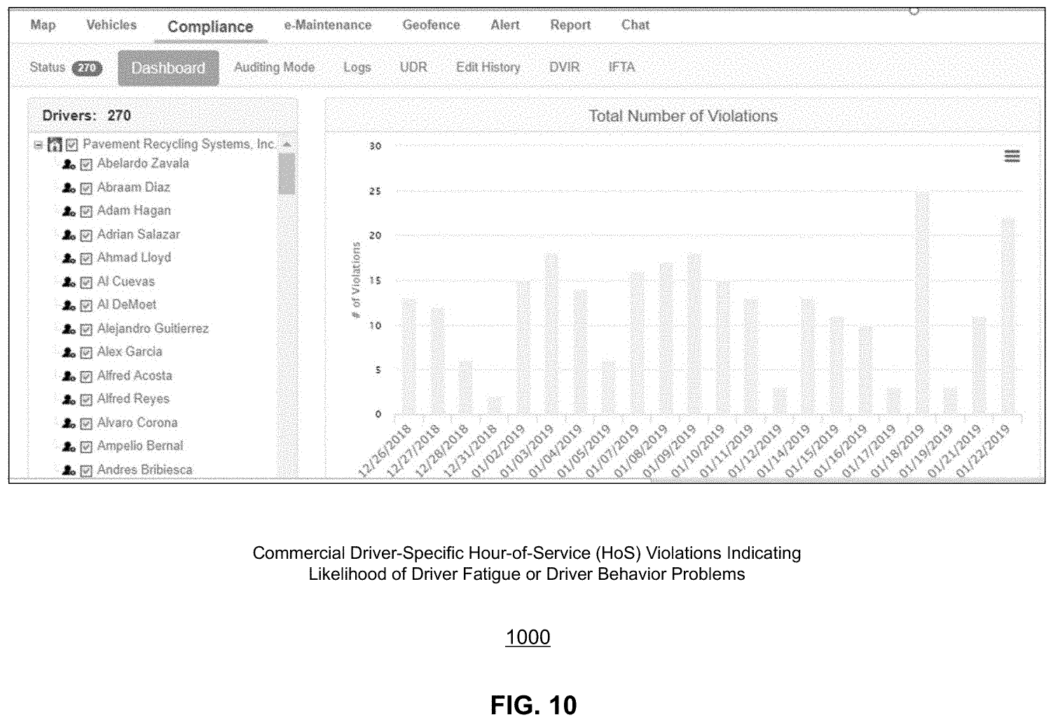

FIG. 10 shows an example (1000) of commercial driver-specific hour-of-service (HoS) violations indicating likelihood of driver fatigue or driver behavior problems, in accordance with an embodiment of the invention. In this example, a list of commercial drivers who are typically associated with a particular commercial vehicle fleet organization is linked to commercial driver-specific HoS violations that indicate federal, state, or municipal regulatory violations involving commercial driving hour limits and mandatory rest requirements.

Furthermore, this example (1000) also shows a total number of violations for a selected group of commercial drivers categorized by calendar dates. The SaaS commercial vehicle and cargo compliance asset tracking operating software platform (e.g. 111 in FIG. 1) and the related machine-sensing and machine-learning (e.g. 113 in FIG. 1) in the commercial vehicle insurance risk scoring system are able to analyze and graph violation incident numbers of the selected group of commercial drivers per day. Importantly, the cumulative violation incidents for the selected commercial drivers or for a commercial fleet comprising the selected group of commercial drivers are directly correlated to numerical values of fatigue driving and driving behavior factors in calculating the insurance risk scores per driver or per commercial fleet.

For instance, higher cumulative violation incidents for the selected commercial drivers result in higher numerical values for fatigue driving and driving behavior factors, before being multiplied by specific weighting ratios for the fatigue driving and driving behavior factors, as illustrated, for example, in FIG. 6 and FIG. 15. Likewise, lower cumulative violation incidents for the selected commercial drivers result in lower numerical values for fatigue driving and driving behavior factors, before being multiplied by specific weighting ratios for the fatigue driving and driving behavior factors, as also illustrated in FIG. 6 and FIG. 15.

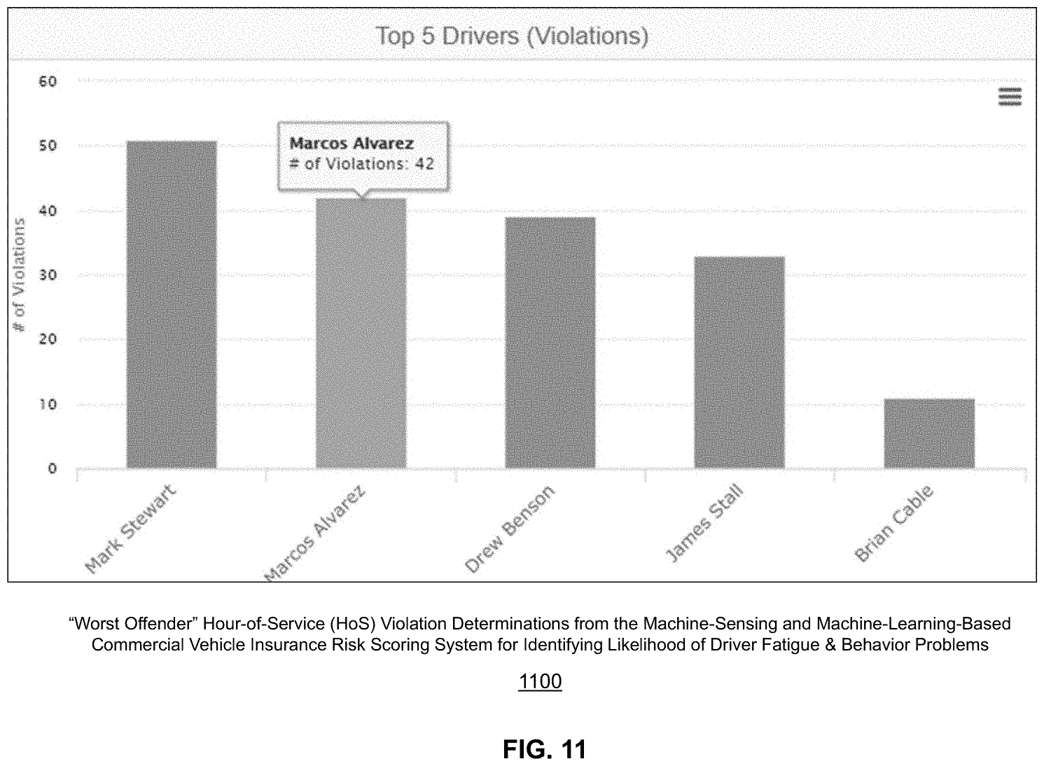

FIG. 11 shows an example (1100) of “worst offender” hour-of-service (HoS) violation determinations from the intelligent machine sensing and machine learning-based commercial vehicle insurance risk scoring system for identifying likelihood of driver fatigue and behavior problems, in accordance with an embodiment of the invention. In this example (1100), names of top 5 “worst offender” drivers are identified by the number of HoS violations related to driving hour limits and resting period requirements. Typically, such HoS violations are autonomously and automatically detected, timestamped, and recorded by in-vehicle sensors and commercial driver electronic logging devices, and subsequently transmitted to the commercial vehicle insurance risk factor determination and scoring modules.

In some instances, an insurance company may want to receive a list of such “worst offenders” in HoS violations to remove them from an insurable pool of commercial drivers. In another instance, the insurance company may want to levy higher insurance premiums for those “worst offenders” or for an vehicle fleet organization containing one or more of those “worst offenders,” as displayed in the example (1100) in FIG. 11. Furthermore, vehicle insurance pricing and risk prioritization parameters (e.g. 307 in FIG. 3, 117 in FIG. 1) from the insurance company, the vehicle fleet organization, or another client to the commercial vehicle insurance risk scoring system may specify threshold values and data filtering conditions for the intelligent machine generation of the “worst offender” list.

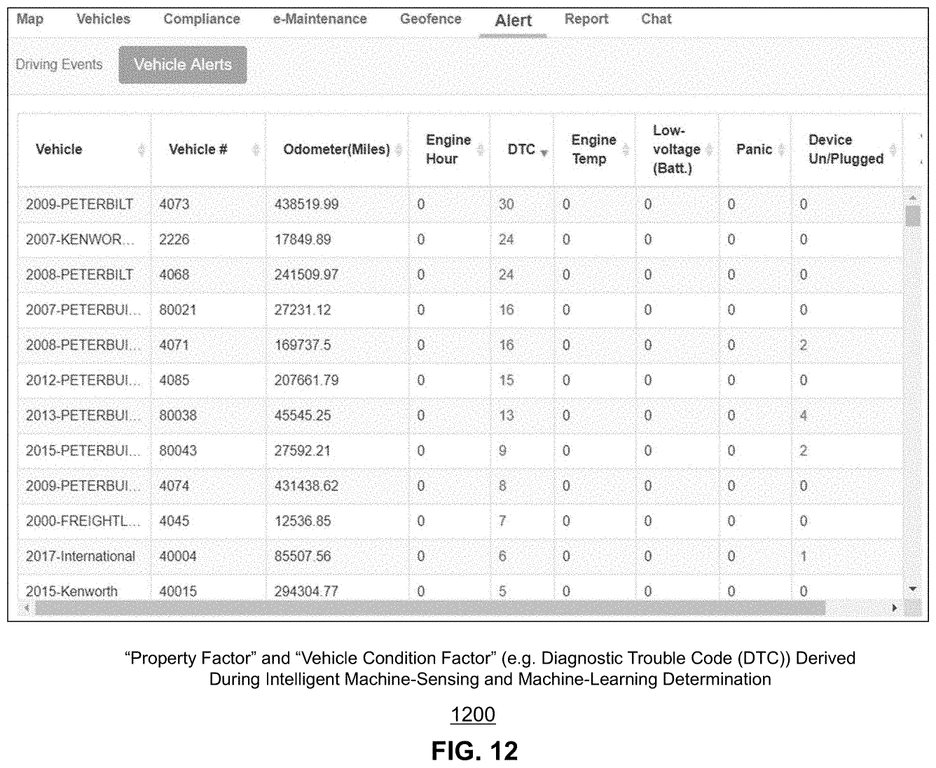

FIG. 12 shows an example (1200) of property factor and vehicle condition factor (e.g. diagnostic trouble code (DTC)) derived during intelligent machine-sensing and machine-learning determination for subsequent calculations of insurance risk scores, in accordance with an embodiment of the invention. In this example (1200), the property factor includes vehicle model and make, production year, and current odometer reading per monitored vehicle. In general, the vehicle property factor in context of insurance risk score calculations impact the insurance risk values based on the current age of the vehicle, the current odometer reading in the vehicle, and any known recalls or problems associated with the vehicle model and make. Typically, the risk value component of this property factor is higher if the vehicle is an older model, a higher-mileage vehicle, or a model with an unusually severe or frequent recall history. Likewise, the risk value component of the vehicle property factor is lower if the vehicle is a newer model, a lower-mileage vehicle, or a model with little to no recalls.

Furthermore, as shown in the example (1200) in FIG. 12, the vehicle condition factor is typically derived from in-vehicle sensors and/or an on-board diagnostic device (OBD) installed in the vehicle, wherein various in-vehicle sensor and OBD readout values are continuously or periodically transmitted wirelessly to the commercial vehicle insurance risk factor determination and scoring modules (e.g. 115 and 121 in FIGS. 1, 205 and 225 in FIG. 2). For instance, any diagnostic trouble codes (DTCs) from the OBD, engine control unit (ECU) output values (e.g. engine temperature, engine RPM, cumulative engine operating hours, etc.), tire pressure sensor values, and other in-vehicle sensor readout values in a monitored commercial vehicle may be wirelessly transmitted to the commercial vehicle insurance risk factor determination and scoring modules for dynamic assessment of insurance risk associated with real-time conditions of the monitored commercial vehicle.

In the preferred embodiment of the invention, if the monitored commercial vehicle has more trouble codes or adverse in-vehicle sensor output values, then the numerical value of the vehicle condition factor component of the insurance risk score increases proportionally. Similarly, if the monitored commercial vehicle has less trouble codes or adverse in-vehicle sensor output values, then the numerical value of the vehicle condition factor component of the insurance risk score decreases proportionally.

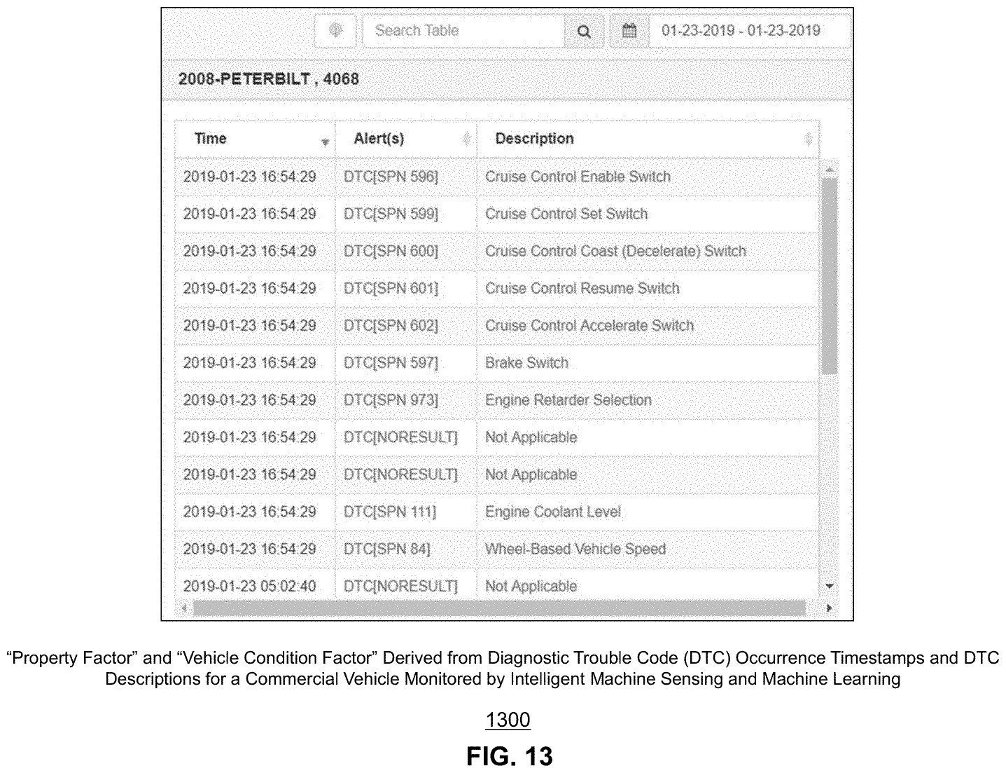

FIG. 13 shows an example (1300) of property factor and vehicle condition factor derived from diagnostic trouble code (DTC) occurrence timestamps and DTC descriptions for a commercial vehicle monitored by intelligent machine sensing and machine learning, in accordance with an embodiment of the invention. In this example, the monitored commercial vehicle (i.e. “2008-Peterbilt, 4068”) generates numerous DTCs, which indicate potential electronic or mechanical problems with the vehicle in real time. The DTCs are dated with occurrence timestamps and categorized as property and vehicle condition factors that impact insurance risk scoring. Then, the categorized DTC timestamps and descriptions are uploaded to the commercial vehicle insurance risk factor determination and scoring modules.

In general, if the monitored commercial vehicle generates more nontrivial DTCs over a day, a week, a month, or another predefined measurement period, numerical values for the property and the vehicle condition factor components in insurance risk score calculations increase proportionally. Likewise, if the monitored commercial vehicle generates less number of nontrivial DTCs or no DTCs at all over a predefined measurement period, the numerical values for the property and the vehicle condition factor components in insurance risk score calculations decrease proportionally.

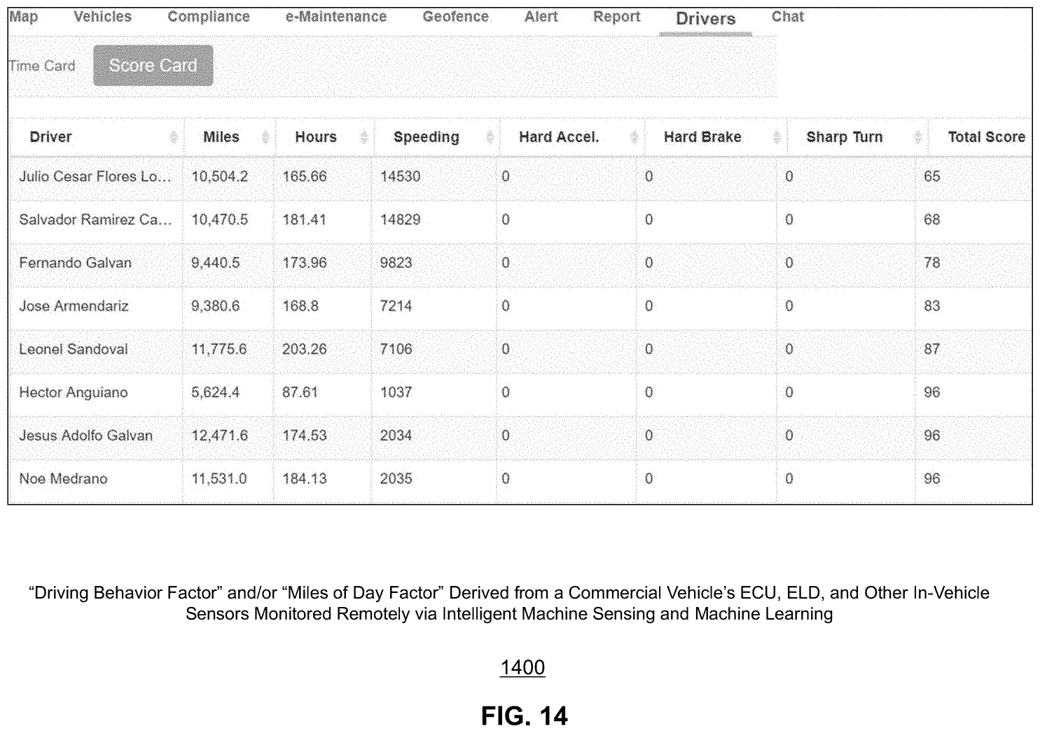

FIG. 14 shows an example (1400) of driving behavior factor and a miles of day factor derived from a commercial vehicle's ECU, ELD, and other in-vehicle sensors monitored remotely via intelligent machine sensing and machine learning, in accordance with an embodiment of the invention. In this example (1400), the names of selected commercial drivers, cumulative miles driven per defined period, number of hours spent operating commercial vehicles per defined period, and number of driving behavior-related infractions or incidents (e.g. speeding, hard acceleration or braking, sharp turns, etc.) are tracked and displayed together for a system operator.

Furthermore, as shown in this example (1400), the commercial vehicle insurance risk scoring system can also generate a driver-specific safety score associated with driving behaviors for the number of miles driven. The driver-specific safety score in FIG. 14 is preferably directly proportional to the safe driving of each driver. Therefore, as shown in the example (1400), a higher driver-specific safety score is achieved when there is less adverse driving behavior-related infractions or incidents (i.e. lower number of incidents involving speeding, hard acceleration or braking, sharp turns, etc.). The driver-specific safety score can also be further utilized as a component in calculating the multi-factor commercial vehicle insurance risk scores, wherein the magnitude of a driver-specific safety score is inversely related to the driving behavior factor component of the multi-factor commercial vehicle insurance risk scores. For instance, a higher driver-specific safety score may contribute to lowering of a multi-factor commercial vehicle insurance risk score and vice versa.

FIG. 15 shows an example (1500) of commercial vehicle insurance risk scores calculated from the intelligent machine sensing and machine learning-based commercial vehicle insurance risk scoring system, in accordance with an embodiment of the invention. In this example (1500), each monitored commercial vehicle is associated with a variety of risk factor components, including a property factor (e.g. vehicle year, identification, and odometer reading), a “risk zone” factor, a “time of day” factor, a “fatigue driving” factor, a “miles of day” factor, a vehicle condition factor, and a driving behavior factor.

Furthermore, each insurance risk factor has a weighting ratio determined by the commercial vehicle insurance risk factor determination module for computation of insurance risk scores. In this particular example (1500), the weighting ratios are set as 10% for the property factor, 25% for the “risk zone” factor, 25% for the “time of day” factor, 15% for the “fatigue driving” factor, 5% for the “miles of day” factor, 10% for the vehicle condition factor, and 10% for the driving behavior factor. Each weighting ratio per factor is multiplied by a numerical value for each factor, which is typically measured on a scale of 0˜100. Because the “risk zone” factor with the weighting ratio of 25% is not utilized in this particular data sample, each commercial vehicle insurance risk score is a result of statistical normalizations with min-max feature scaling to bring all comparable scores within a certain scale (e.g. 0˜100). The computation of the min-max feature scale is well-known and mathematically well-defined in the field of statistics. In this particular case, the min-max feature scaling is achieved by subtracting the lowest score in the data sample from the score that requires normalization, divided by a result from the lowest score subtracted from the highest score in the data sample, after which the resulting value is multiplied by 100 to complete the min-max feature scaling to 0˜100 range, as exemplified by the data sample results in FIG. 15.

For example, for Vehicle #651194 shown as the first entry in FIG. 15, the “time of day” factor sub-score is 73.05 out of 100, and the “miles of day” factor sub-score is 34.61 out of 100, wherein a higher subs-core indicates a higher insurance risk for that factor. Each sub-score is multiplied by each factor's respective weighting ratio (e.g. 73.05×0.25 for the “time of day” factor, 34.61×0.05 for the “miles of day” factor), and added together to produce an overall insurance risk score per monitored vehicle, wherein the overall insurance risk score is then statistically normalized with the min-max feature scaling to 0˜100 range because the “risk zone” factor category and its weighting ratio are not utilized in the computation of scores in this particular data sample. The min-max feature-scaled and normalized insurance risk score for Vehicle #651194 is 97.14, as shown in the example (1500) in FIG. 15. The min-max feature-scaled and normalized insurance risk scores among a plurality of monitored vehicles are directly comparable to each other as indicators of vehicle insurance risk assessments, with a higher score suggesting a higher insurance risk and a lower score suggesting a lower insurance risk within the statistically-normalized 0˜100 range in measurement scale.

Various embodiments of the present invention provide several key advantages over conventional methods of vehicle insurance risk determinations and related insurance premium pricing. One advantage of an embodiment of the present invention is providing a novel electronic system that incorporates vehicular sensory parameters and electronic commercial driver log and behavioral information in real-time to extrapolate most relevant vehicle insurance risk factors for precise determinations of insurance premiums.

Furthermore, another advantage of an embodiment of the present invention is providing an intelligent machine-determined commercial vehicle insurance risk scoring module for the novel electronic system that infuses historical accident risk statistics and real-time vehicular sensor and driver-related parameters to generate a dynamic and accurate insurance risk score for a particular commercial vehicle or a particular commercial vehicle driver.

In addition, another advantage of an embodiment of the present invention is providing a dynamic and accurate insurance risk score derived from the novel electronic system for rapid identification of troublemaking commercial drivers or commercial vehicles that cause outsized insurance premiums, accident risks, and/or regulatory violations.

Moreover, another advantage of an embodiment of the present invention is providing novel electronic user interfaces from the novel electronic system to commercial vehicle fleet operators or insurance companies to identify, alert, and manage insurance risk scores and potential troublemaking entities for reduced insurance premiums, accident risks, and regulatory violations.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An intelligent machine sensing and machine learning-based commercial vehicle insurance risk scoring system comprising:
a vehicle on-board diagnostics (OBD) device connected to an engine control unit (ECU), an in-vehicle sensor, or a vehicular control chip in a vehicle to record, diagnose, and generate an engine on or off status, vehicle speed data, acceleration and deceleration data, ambient air temperature data, and diagnostic trouble codes (DTCs) as a raw OBD data stream;
a vehicle electronic logging device (ELD) connected to the vehicle OBD device, wherein the vehicle ELD is configured to generate a driver-specific ELD log that contains a currently logged-in driver's on-duty, off-duty, and resting activities associated with the vehicle;
an accident-causality historical and statistical database executed on a computer server;
an intelligent machine sensing and machine learning-based commercial vehicle insurance risk factor determination module connected to the vehicle OBD device, the vehicle ELD, and the accident-causality historical and statistical database to identify a plurality of insurance risk factors, to assign a numerical value for each insurance risk factor per monitored vehicle, and to determine a weighting ratio per insurance risk factor after analyzing the raw OBD data stream, the driver-specific ELD log, and accident-causality statistics from the accident-causality historical and statistical database, wherein each weighing ratio is directly proportional to a closeness of correlation between an insurance risk factor and an actual accident caused by a particular insurance risk factor;
a commercial vehicle insurance risk scoring module connected to the intelligent machine sensing and machine learning-based commercial vehicle insurance risk factor determination module, wherein the commercial vehicle insurance risk scoring module derives a commercial vehicle insurance risk score by multiplying the numerical value for each insurance risk factor per monitored vehicle with the weighting ratio per insurance risk factor to generate a plurality of sub-scores from all insurance risk factors, and then by adding all sub-scores and performing a statistical normalization with a min-max feature scaling to produce the commercial vehicle insurance risk score;
an ELD and OBD data transceiver connected to the vehicle ELD and the vehicle OBD device, wherein the ELD and OBD data transceiver is configured to transmit the raw OBD data stream and the driver-specific ELD log to components of the intelligent machine sensing and machine learning-based commercial vehicle insurance risk scoring system located outside the vehicle; and
a data communication network configured to provide a wireless data information transfer among the ELD and OBD data transceiver, the accident-causality historical and statistical database, the intelligent machine sensing and machine learning-based commercial vehicle insurance risk factor determination module, and the commercial vehicle insurance risk scoring module.

2. The intelligent machine sensing and machine learning-based commercial vehicle insurance risk scoring system of claim 1, further comprising an hour-of-service (HoS) entry and guidance application executed on a portable electronic device for a commercial vehicle driver, wherein the HoS entry and guidance application enables the commercial vehicle driver to enter or modify the driver-specific ELD log.

3. The intelligent machine sensing and machine learning-based commercial vehicle insurance risk scoring system of claim 1, further comprising a commercial vehicle insurance company's vehicle insurance pricing and data parameter interface executed on the computer server to specify a vehicle insurer's conditions for identifying worst offending vehicles or drivers who are subject to removal from a vehicle fleet insurance plan to retain or reduce insurance premiums.

4. The intelligent machine sensing and machine learning-based commercial vehicle insurance risk scoring system of claim 1, further comprising an insurance risk management application executed on an electronic device located at a vehicle fleet monitoring station of a vehicle fleet organization or a commercial vehicle insurance company.

5. The intelligent machine sensing and machine learning-based commercial vehicle insurance risk scoring system of claim 1, wherein the plurality of insurance risk factors comprises a property factor, a “risk zone” factor, a “time of day” factor, a fatigue driving factor, a “miles of day” factor, a vehicle condition factor, and a driving behavior factor, which is identified and analyzed from the raw OBD data stream, the driver-specific ELD log, and the accident-causality statistics from the accident-causality historical and statistical database.

6. The intelligent machine sensing and machine learning-based commercial vehicle insurance risk scoring system of claim 1, further comprising a commercial vehicle and cargo compliance asset tracking software platform that connects and manages the in-vehicle sensor, the vehicle ELD, and a commercial trucking load or asset-tracking device to communicate with the intelligent machine sensing and machine learning-based commercial vehicle insurance risk factor determination module, which is executed by the computer server outside of the vehicle.

7. The intelligent machine sensing and machine learning-based commercial vehicle insurance risk scoring system of claim 1, wherein a higher value in the commercial vehicle insurance risk score indicates a higher insurance risk for a particular driver or a particular commercial vehicle.

8. The intelligent machine sensing and machine learning-based commercial vehicle insurance risk scoring system of claim 1, wherein a lower value in the commercial vehicle insurance risk score indicates a lower insurance risk for a particular driver or a particular commercial vehicle.

9. The intelligent machine sensing and machine learning-based commercial vehicle insurance risk scoring system of claim 1, wherein the intelligent machine sensing and machine learning-based commercial vehicle insurance risk factor determination module incorporates a machine-sensed and machine-learned real-time property factor, time of day factor, fatigue driving factor, miles of day factor, vehicle condition factor, and driving behavior factor accumulation module, a government or third-party accident statistics download module for risk zone, time of day, and other accident factors, a vehicle insurance pricing and risk prioritization parameters from a client company, a commercial insurance risk factor validation and risk factor proportional weighting determination module, a system adjustment and management user interface, and an information display and communication management module.

10. The intelligent machine sensing and machine learning-based commercial vehicle insurance risk scoring system of claim 1, wherein the commercial vehicle insurance risk scoring module incorporates a commercial insurance risk factor weighting calculation and adjustment module, a commercial vehicle insurance risk score generator, a high risk vehicle determination and alert module, a system adjustment and management user interface, and an information display and communication management module to generate commercial vehicle insurance risk scores and machine-determined high-risk vehicle and driver lists.

11. The intelligent machine sensing and machine learning-based commercial vehicle insurance risk scoring system of claim 1, wherein the vehicle is a truck, a bus, a van, a taxi, or another commercially-operated vehicle.

12. The intelligent machine sensing and machine learning-based commercial vehicle insurance risk scoring system of claim 1, wherein the commercial vehicle insurance risk score is an objective metric for comparing insurance and safety risks among a plurality of commercial vehicle drivers and commercial vehicles.
